(19) United States
(12) Patent Application Publication
(10) Pub. No.: US 2021/0119569 A1
(43) Pub. Date: Apr. 22, 2021

(54) METHOD FOR IMPLEMENTING ATMOSPHERIC POWER GENERATION SYSTEM, AND POWER GENERATION SYSTEM THEREOF

(71) Applicant: RADIANCE CO., LTD., Seongnam (KR)

(72) Inventors: Se Yeong KIM, Seoul (KR); Dong Woo KIM, Seoul (KR)

(21) Appl. No.: 17/043,410

(22) PCT Filed: Apr. 5, 2019
(86) PCT No.: PCT/KR2019/004022

§ 371 Date: Sep. 29, 2020

(30) Foreign Application Priority Data
Apr. 5, 2018 (KR) 10-2018-0039495

(51) Int. Cl. H02S 10/20; H02S 40/34

(52) U.S. Cl. CPC H02S 10/20; H02S 40/34

(57) ABSTRACT

An atmospheric power generation system is proposed. The system includes: a photovoltaic power generator that is a photovoltaic power generation facility producing (generating) electricity using light energy of the sun in the sky; an electricity storage device connected to photovoltaic power generator through electrical circuits, storing (accumulating) electricity produced (generated) by the photovoltaic power generator in the sky such that the stored (accumulated) electricity can be transmitted to a designated electrical energy distribution place; an electrical energy transporter including the photovoltaic power generator and the electricity storage device and performing an electricity producing/transporting cycle one time or continuously two or more times between the sky and the designated electrical energy distribution place; a designated electrical energy distribution place receiving electrical energy brought by the electrical energy transporter from the sky by producing (generating) and storing photovoltaic electricity, or transmitting the received electrical energy to an electricity consumer.

### TECHNICAL FIELD

The present disclosure relates to a method for implementing an atmospheric power generation system and a power generation system thereof and, more particularly, to a method for implementing an atmospheric power generation system, the method bringing electrical energy generated in the sky to a designated electrical energy distribution place through a delivery cycle and then transmitting the electrical energy to an electricity consumer (electricity customer), and a power generation system thereof.

### BACKGROUND ART

Fossil fuels such as coal, oil, natural gas, etc. accounting for about 80% of the energy that is used around the world are being exhausted.

Oil that is the most generally used at present as an energy resource is usually used as the fuel of transportation and natural gas that is obtained from the upper part of crude oil is produced in a liquid state and used as the raw material of chemical products, gas for heating, etc.

However, the consumption of fossil fuels has doubled every twenty years from 1900 and environment scientists expect that fossil fuels will be drained within the next 50 to 200 years.

Further, fossil fuels are the main contributor to environmental contamination, and particularly, oil discharges carbon that is one of the greenhouse gases.

Such environmental contamination due to fossil fuels makes global warming and air pollution due to fine dust severe, increases abnormal climate change, and threatens the health of humans.

Meanwhile, humans have developed nuclear power plants to replace use of fossil fuels, but the danger and problems with management of nuclear power generation have been revealed through the Three Mile Island accident in the US, the Chernobyl nuclear accident in former Soviet Union, and the recent Fukushima nuclear accident due to the Tohoku earthquake, and humans realized that reducing operation of nuclear power plants or completely shutting down nuclear power plants is substantially the only way we can more safely live.

Accordingly, in order to solve the problem of coming energy exhaustion that is so-called the exhaustion of fossil fuels and the problem of the severe side effect that is environmental contamination due to consumption of fossil fuels, and in order to reduce or completely shut down nuclear power plants, humans necessarily needs to new future energy in the future.

However, the amount of energy that humans use is too much and the use amount keep increasing, so there is a need for substitute energy.

Such Future Energy

should be able to be constantly produced in a permanent (continuous) way without exhaustion and should be produced in a way that can almost infinitely produce a large amount of energy such that it is sufficient no matter how much humans use it in the future, whereby it could have requirement as new future energy for humans. Further, the future energy should be produced in a clean and non-contaminating way in order not to generate an environmental contamination problem like fossil fuels and should be produced without a safety problem like a nuclear power plant.

However, there is a problem that humans do not have a technology that produces such future energy or a method of accomplishing (implementing) the technology up to now.

### DISCLOSURE

### Technical Problem

The present disclosure has been made in an effort to solve the problems described above and an objective of the present disclosure is to provide a method for implementing an atmospheric power generation system that can constantly produce a large amount of energy in a permanent (continuous) way without exhaustion and can almost infinitely produce a large amount of energy such that the energy is sufficient no matter how much humans use the energy in the future, and a power generation system thereof.

Another objective of the present disclosure is to provide a method for implementing an atmospheric power generation system that can produce energy in a clean and non-contaminating way in order not to generate an environmental contamination problem like fossil fuels and without a safety problem like a nuclear power plant, and a power generation system thereof.

### Technical Solution

In order to achieve the objectives, a method for implementing an atmospheric power generation system according to an embodiment of the present disclosure includes: (a) configuring a photovoltaic power generator that is a photovoltaic power generation facility producing (generating) electricity using light energy of the sun in the sky;

(b) configuring an electricity storage device storing (accumulating) electricity produced (generated) by the photovoltaic power generator in the sky such that the stored (accumulated) electricity can be transmitted to a designated electrical energy distribution place;

(c) configuring an electrical energy transporter including the photovoltaic power generator and the electricity storage device and performing an electricity producing/transporting cycle one time or continuously two or more times between the sky and the designated electrical energy distribution place;

(d) configuring a designated electrical energy distribution place receiving electrical energy brought by the electrical energy transporter from the sky by producing (generating) and storing photovoltaic electricity, or transmitting the received electrical energy to an electricity consumer;

(e) connecting electrical circuits such that electricity produced (generated) by the photovoltaic power generator is stored (accumulated) in the electricity storage device while the electrical energy transporter stays in the sky; and

(f) bringing electrical energy produced (generated) in the sky to the designated electrical energy distribution place by performing the electricity producing/transporting cycle between the sky and the designated electrical energy distribution place

by means of the electrical energy transporter.

An atmospheric power generation system according to an embodiment of the present disclosure includes: a photovoltaic power generator that is a photovoltaic power generation facility producing (generating) electricity using light energy of the sun in the sky;

an electricity storage device connected to photovoltaic power generator through electrical circuits, storing (accumulating) electricity produced (generated) by the photovoltaic power generator in the sky such that the stored (accumulated) electricity can be transmitted to a designated electrical energy distribution place;

an electrical energy transporter including the photovoltaic power generator and the electricity storage device and performing an electricity producing/transporting cycle one time or continuously two or more times between the sky and the designated electrical energy distribution place; and

a designated electrical energy distribution place receiving electrical energy brought by the electrical energy transporter from the sky by producing (generating) and storing photovoltaic electricity, or transmitting the received electrical energy to an electricity consumer,

in which the electrical energy transporter brings electrical energy produced (generated) in the sky to the designated electrical energy distribution place by performing the electricity producing/transporting cycle between the sky and the designated electrical energy distribution place.

### Advantageous Effects

According to the technical solution, it is possible to continuously produce an almost infinite amount of energy permanently (eternally) without energy exhaustion such that humans can infinitely use the energy without shortage in the future.

Further, it is possible to produce electricity in a clean and non-contaminating way without generating an environmental contamination problem like fossil fuel and the problem of safety like a nuclear power plant.

### DESCRIPTION OF DRAWINGS

FIG. 1 is a block diagram of an atmospheric power generation system according to an embodiment of the present disclosure; and

FIG. 2 is a flowchart showing a method for implementing an atmospheric power generation system according to an embodiment of the present disclosure.

### MODE FOR INVENTION

Hereafter, the configuration and operation of embodiments of the present disclosure are described with reference to the accompanying drawings.

### Embodiment 1

As described above in the background, humans necessarily need to a technology (method) that can replace fossil fuels and nuclear power plants in the future.

Such future energy should be able to be constantly produced in a permanent (continuous) way without exhaustion and should be produced in a way that can almost infinitely produce a large amount of energy such that it is sufficient no matter how much humans use it in the future, whereby it could have requirement as new future energy for humans. Further, the future energy should be produced in a safe, clean, and non-contaminating way that does not generate an environmental contamination problem like fossil fuels and the problem of safety like a nuclear power plant.

Accordingly, the following methods should be preceded to secure a future energy production technology (method) that can replace fossil fuels and nuclear power plants.

First, the future substitute energy for humans should be electrical energy.

This is because electrical energy is clean (without the aftereffect of environmental contamination), is convenient to use, and has become the most important energy that has to be used in all industrial fields.

Second, in order to produce (generate) electricity in a method that can constantly produce electrical energy in a permanent (continuous) way without exhaustion and can almost infinitely produce a large amount of energy such that the energy is sufficient no matter how much humans use the energy in the future and a safe and clean method, electrical energy should be (produced) generated necessarily in a photovoltaic power generation type.

This is because the light (which is an electromagnetic wave and energy transmitted by particles and waves) from the sun is energy that is permanently (eternally) sent to the earth and space as long as a sun (permanent star) exists and is energy that is infinitely supplied in a large amount (energy that is sent from the sun to the earth or space in a large amount such that it cannot be measured, that is, an infinitely large amount of energy) and it is possible to produce (generate) electrical energy most safely and cleanly without contamination when producing electrical energy in the photovoltaic power generation type.

For reference, the total amount of the energy that is transmitted to the surface of the earth from the sun for one hour is 174,000 TWh (1 TWh is 1 billion kWh), which nine times the amount of power generated in the entire world in 2008 (the amount of energy of sunlight transmitted to the earth for about 7 minutes is larger than the energy usage for one year of the world) (by Ministry of Trade, Industry and Energy of Korea).

Third, the place for photovoltaic power generation described in the second method should be in the sky or in space.

Photovoltaic power generation facilities for photovoltaic power generation require solar cells (solar modules) for producing (generating) electricity using sunlight, and the larger the surface that receives sunlight and the larger the number of the solar cells, the more electricity the solar cells produce (generate).

However, the solar cells that humans developed up to now produce (generate) a small amount of electricity with respect to the installation area, so a huge installation area is required to install photovoltaic power generation facilities and produce (generate) electricity (power) as humans substantially need.

Further, the larger the installation area of a photovoltaic power generation facility, the larger the installation area cost (land price), and the larger the installation area cost, the larger the cost for producing (generating) electricity, which decreases economic efficiency.

Accordingly, in order to produce (generate) a large amount of almost infinite energy that humans will need in the future and to install necessary photovoltaic power generation facilities, an almost infinitely huge installation area is required. Constructing such an almost infinite installation area on the ground increases the installation area cost and the cost for producing (generating) electricity, which will reduce or remove economic efficiency. Further, since there is a realistic limitation that the area on the ground (installation chamber) is not finite, it is substantially impossible to construct an infinite installation area on the ground in order to install only photovoltaic power generation facilities.

However, there are infinite spaces in the sky and in space and the installation area cost is zero, thus it is possible to realize an infinite installation area and it is also possible to make the installation area cost be zero only when producing (generating) electricity in the sky or in space using a photovoltaic power generation facility. Accordingly, it is possible to secure a substantially economical condition for producing an almost infinite large amount of energy as photovoltaic electricity.

Further, the more intense sunlight and the more the direct sunlight, the larger the amount of photovoltaic power generation from the same photovoltaic power generation facility (a solar cell, a solar module, etc.). Sunlight is much more intense in the sky or in space than on the ground of the earth (the higher the altitude in the sky, the lower the air density, so the air blocking sunlight decreases and sunlight becomes intense), and the sky and space are advantageous to receive the direct sunlight. Accordingly, there is an advantage that much electricity is generated than when photovoltaic power generation is performed on the ground.

Further, sunlight is incident to the ground only during the day and sunlight that is substantially used for a photovoltaic power generation facility to generate electricity is at most about 4 hours for one day, but sunlight is incident to the sky longer than the ground and sunlight is present in space (the outer space) for 24 hours. Accordingly, it is possible to further produce (generate) electricity from sunlight by at least 3 to 12 times that obtained on the ground when flying and deploying a photovoltaic power generation facility in the sky or space (the outer space) and controlling the photovoltaic power generation system to follow sunlight and direct sunlight.

Accordingly, the technology (method) for humans to be able to produce substitute energy, which will replace fossil fuels and nuclear power plants, permanently (eternally), and infinitely, and particularly, the most safely and cleanly, is an optimal method composed of all of the first to third methods described above. That is, the method for implementing an atmospheric power generation system, and the power generation system thereof are the most ideal and unique means.

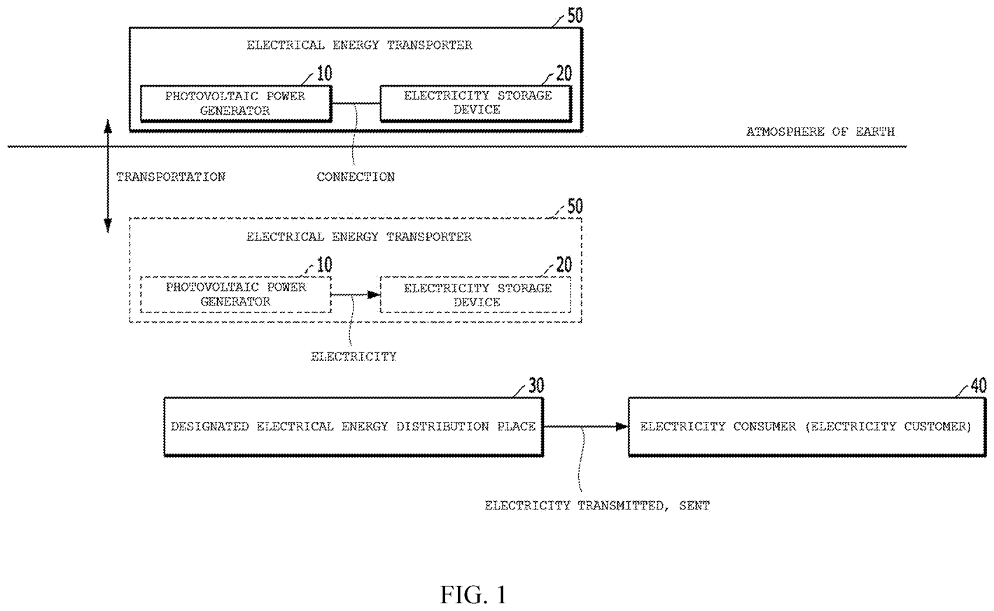

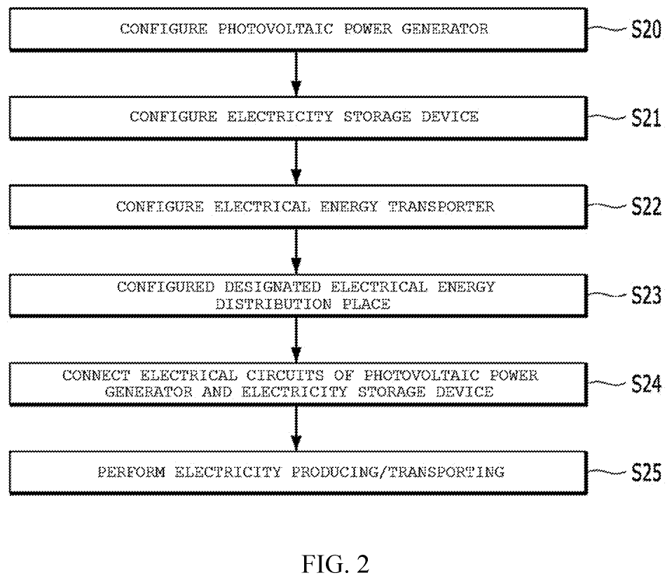

The method for implementing an atmospheric power generation system according to the present disclosure, as shown in FIGS. 1 and 2, includes:

(a) a step of configuring a photovoltaic power generator 10 that is a photovoltaic power generation facility producing (generating) electricity using the light energy of the sun in the sky or in space (S20);

(b) a step of configuring an electricity storage device 20 storing (accumulating) electricity produced (generated) by the photovoltaic power generator 10 in the sky or in space such that the stored (accumulated) electricity can be transmitted to a designated electrical energy distribution place 30 (S21);

(c) a step of configuring an electrical energy transporter 50 including the photovoltaic power generator 10 and the electricity storage device 20 and performing an electricity producing/transporting cycle one time or continuously two or more times between the sky or in space and the designated electrical energy distribution place 30 (S22); and

(d) a step of configuring a designated electrical energy distribution place 30 that receives electrical energy brought by the electrical energy transporter 50 from the sky or space by producing (generating) and storing photovoltaic electricity, or that transmits the received electrical energy to

an electricity consumer (electricity customer) (S23).

### Embodiment 2

The method may further include a step of connecting the photovoltaic power generator 10 and the electricity storage device 20 to each other through an electrical circuit so that the electricity produced (generated) by the photovoltaic power generator 10 is stored in the electricity storage device 20 while the electrical energy transporter 50 stays in the sky (S24).

The step (c) (S22) is described in detail hereafter.

To this end, as a method for humans to almost infinitely and almost permanently produce (generate) electricity (energy) that is clean energy through photovoltaics as substitute energy of fossil fuel energy by combining all of the first to third methods in <Embodiment 1>, an example 1 is described.

First, assuming that one of the designated electrical energy distribution places 30 in <Embodiment 1> is a Seoul charging station on the ground in Seoul of Korea, a drone is selected as the electricity energy transporter 50 that reciprocates between the sky and the Seoul charging station and then a solar cell is installed on the drone to receive sunlight well in the sky (e.g., a foldable solar module is installed to be folded when going up to the sky from the ground and is then deployed to face the sun in the sky to be able to receive more direct sunlight through a larger area).

Further, an energy storage system (ESS) is further installed on the drone as the electricity storage system that can perform well the function of storing (accumulating) and transporting energy produced (generated) by the solar cell on the drone to the Seoul charging station on the ground and the function of transmitting (discharging or delivering) well the stored (accumulated) electricity at the Seoul charging station.

When the drone goes up to the sky and deploys the foldable solar cell, electricity starts to be produced (generated) and the produced (generated) electricity is stored in the energy storage system (ESS) installed on the drone. When the electricity is sufficiently stored (accumulated) in the energy storage system (ESS) by the capacity, the drone comes down to the Seoul charging station on the ground, discharges the electricity stored (accumulated) in the sky to a large-capacity electricity storage system (an energy storage system (ESS) having large capacity) installed at the charging station to transmit electricity (charges the large-capacity electricity storage system), and then repeats going up to the sky and storing electricity again and then coming down to the charging station on the ground and discharging the electricity. The electricity stored in this way in the large-capacity electricity storage system installed at the charging station on the ground is transmitted, distributed, or sent to customers (consumers) requiring energy (electricity) on the ground.

Further, if the drone is made as a drone that has a large size to be able to mount a photovoltaic facility, which can generate more electricity, and a photovoltaic electricity storage device, which can store more electricity, and that has an improved performance to be able to go up to the air with larger weight, and such a drone having an improved performance is infinitely made over one or more, hundreds of thousands, or hundreds of millions and is continuously reciprocated among a large number of designated electrical energy distribution places 50 (like the Seoul charging station) in <Embodiment 1> installed in the sky, on the ground, in the sea, or in the air of the earth to produce, store, and transport electricity to the designated electrical energy distribution places 50, humans can almost permanently (eternally) and almost infinitely produce (generate) and obtain a large amount of energy in the most safe and clean way in the future by the present disclosure.

Assuming that the energy (electricity) is ‘future energy’, it will be possible to completely replace fossil energy with the future energy that is taken from the sky or space, it will possible to reduce or completely shut down nuclear power plants, and it will also possible to completely solve the environment problem of the earth and the energy exhaustion problem.

Consequently, the description of the example 1 is described again.

The electrical energy transporter 50 in the step (c) of <Embodiment 1> should be an aircraft that:

includes the photovoltaic power generator 10 that is a photovoltaic power generation facility producing (generating) electrical energy using the light energy from the sun in the sky or in space in the step (a) (S20) of <Embodiment 1>;

includes the electricity storage device 20 including the function of storing (accumulating) the electricity produced (generated) by the photovoltaic power generator 10 in the sky or in space and transmitting the stored (accumulated) electricity to designated electrical energy distribution places in the step (b) (S21) in <Embodiment 1>;

performs the step (S24) connecting electrical circuits to each other so that the electricity produced (generated) by the photovoltaic power generator 10 is stored (accumulate) in the electricity storage device 20 while staying in the sky or in space (outer space);

comes back to the designated electrical energy distribution places 30 to transmit the electrical energy brought from the sky or space; and

continuously repeats the electricity producing/transporting cycle one time or two or more times between the designated electrical energy distribution places 30 and the sky or space,

thereby performing a step of storing (accumulating) the photovoltaic electricity produced (generated) by the photovoltaic power generator 10 in the sky or in space to the electricity storage device 20 and then bringing the electricity to the designated electrical energy distribution places 30.

Further, it is more effective that

the aircraft is a drone.

Further, the electricity producing/transporting cycle in the step (c) (S22) in <Embodiment 1> is

a series of processes in which the electrical energy transporter 50 flies up to the sky or space (outer space), produces (generates) and accumulates (stores) photovoltaic electricity while staying in the sky or space (outer space), and then comes back and transmits the brought electrical energy to the designated electrical energy distribution places 30.

### Embodiment 3

In order to substantially accomplish the present disclosure,

the electrical energy transporter 50 of <Embodiment 1> and <Embodiment 2> should be manufactured

such that the total amount of electrical energy produced (generated) and brought (transported) to the designated electrical energy distribution places 30 from the sky or space by through one time of the electricity producing/transporting cycle is larger than the total amount of energy that is used (consumed) through one time of the electricity producing/transporting cycle.

In detail,

it is possible to produce an almost infinitely large amount of energy and the energy can have the requirement as the future energy that the present disclosure pursues, only when the total amount of energy (electrical energy) that is produced (generated) through the photovoltaic power generator in the sky or space, is stored (accumulated) in the electricity storage device, and is then brought (transported) to designated electrical energy distribution places 30 by the electrical energy transporter 50 is larger than the total amount of energy (electrical energy and other energy) that is used (consumed) in all of the process of producing (generating) the energy (electrical energy) in the sky or space and the process of transporting the energy to the designated electrical energy distribution places 30 from the sky or space.

The objective of the method for implementing an atmosphere power generation system of the present disclosure is to solve the limitation that is the exhaustion of energy, which humans use, in the future, the problem of fossil fuels that make the environmental problems due to air pollution, fine dust, and discharge of carbon, and the problem of the danger of nuclear power plants and safety such as management that humans further has realized from the recent Fukushima nuclear accident in Japan.

If the total amount of electrical energy that the electrical energy transporter 50 produces, stores, and brings from the sky or space is less than the total amount of energy used (consumed) in this process, the objective of the present disclosure cannot be accomplished.

This is because when the total amount of energy produced and brought in this way is larger than the total amount of energy used for the production, it is required to supplement the additional energy used for producing and bringing (the produced and brought total energy−the total energy used for producing and bringing=additionally consumed energy), which results in unnecessarily making a large amount of new additional demands for supplementing the additionally consumption energy to humans due to the present disclosure.

In order to cope with the new additional demands for supplementing the additionally consumed energy, it is unavoidable to produce the supplementary energy (additionally consumed energy) by using fossil fuels (jet-fuel, etc.) or using the electrical energy that is obtained by operating a thermal power plant obtaining electricity by burning fossil fuels or a nuclear power plant having the danger of nuclear leakage, treatment, and management (it is unavoidable to obtain the additionally consumed energy required by the electrical energy transporter from such electricity).

The reason is that this leads to a counter result that promotes exhaustion of the fossil fuel energy earlier and necessarily increases construction (operation) of nuclear power plants.

Accordingly, in order to accomplish the present disclosure,

the electrical energy transporter 50 of <Embodiment 1> and <Embodiment 2> should be manufactured

such that the total amount of electrical energy produced (generated) and brought (transported) to the designated electrical energy distribution places from the sky or space through one time of the electricity producing/transporting cycle is larger than the total amount of energy that is used (consumed) through one time of the electricity producing/transporting cycle.

Further, in order to substantially implement the method,

the electrical energy transporter 50 of <Embodiment 1> and <Embodiment 2> should be manufactured

such that a portion or the entirety of the energy required to operate (drive) the electrical energy transporter 50 is

supplied from the power (energy) nature naturally obtained by maximally using the principle of nature (or the order of the universe, etc.) and

such that the electrical energy transporter 50 is operated (driven) by the power (energy) of nature without using separate energy as possible as it can.

Further, in order to supply a portion or the entirety of the energy required to operate (driving) the electrical energy transporter 50 using the power of nature,

the electrical energy transporter 50 of <Embodiment 1> and <Embodiment 2> should be manufactured

such that a large amount of energy, which is required when the electrical energy transporter 50 is flown to the sky or space, stays in the sky or space, returns to a designated electrical energy distribution place from the sky or space, is operated (driven) in other operating (driving) periods where a large amount of energy is consumed, etc.,

can be obtained from the power (energy) of nature that is naturally obtained by using the principle of nature (or the order of the universe, etc.) even though the electrical energy transporter 50 hardly separately consumes energy.

This is because since the energy that is consumed in any one or more periods of when the electrical energy transporter 50 flies to the sky or space, stays in the sky or space, returns to a designated electrical energy distribution place 30 from the sky or space, is operated (driven) in other operating (driving) periods where a large amount of energy is consumed, etc. accounts for most of the total energy consumption required to move (drive) the electrical energy transporter 50,

it is possible to easily achieve the objective only when it is possible to remarkably reduce the large amount of energy consumption for operation in the periods which accounts for most of the energy used to move (drive) the electrical energy transporter 50 or it is possible to make the energy consumption itself be zero (100% free).

Further, this is because since it is possible to remarkably reduce energy consumption or make energy consumption itself be zero (100% free) only when it is possible to use energy, which is obtained for free even without separately consuming energy, in order to supply the large amount of energy required for operation in the periods.

So, it is possible to remarkably reduce a large amount of energy consumption or make energy consumption itself be zero (100% free) only when it is possible to supply the large amount of necessary energy using the power (energy) of nature naturally obtained by using the principle of nature (or the order of the universe, etc.), which is the most feasible method.

Further, the more effective one of the kinds of the force of nature that is naturally obtained without separate energy consumption by using the principle of nature (or the order of the universe, etc.) is buoyancy in the air that acts up in the air opposite the gravity of the earth.

The buoyancy in the air is any one or more of natural buoyancy generated by a buoyant substance and artificial buoyancy generated by applying negative (−) pressure or vacuum to artificially generate buoyancy.

When a chamber having a predetermined volume (an object having a chamber with a predetermined volume) is filled with a buoyant substance, buoyancy is naturally provided to the chamber having the volume or the object (fluid) having the chamber, which is natural buoyancy.

The buoyant substance has to have density lower than the density of the air to generate the buoyancy effect in the sky (air).

The air generates force (atmospheric pressure) pulled (pressing) toward the center of gravity (ground) of the earth by the gravity in the atmosphere, fluids (substitute fluids) other than the air are pressed by the air and air buoyancy (buoyancy in the air that pushes up an object in the air opposite the gravity of the earth) is applied to objects (substitute fluids) having density lower than the density of the air by the difference between the mass per volume thereof and the mass per volume of the air.

Accordingly, the buoyant substance has to generate buoyancy in the sky (air) over the ground, and for this purpose, it has to have density lower than the density of the air.

Further, in order to easily achieve the objective, it is required to use buoyancy, which is the force of nature obtained by a buoyant substance having density lower than the density of the air, for most of the periods where a lot (large amount) of energy is used to operate (drive) the electrical energy transporter by substantially applying the buoyant substance to the electrical energy transporter 50. However, the buoyant substance should be able to be substantially applied to the electrical energy transporter.

Therefore, according to actual tests, helium gas, hydrogen gas, methane gas, nitrogen, etc. can be used as buoyant substances that are more easily applied to the electrical energy transporter, and

when these substances are applied to the electrical energy transporter, they can easily generate buoyancy and convenience of use is improved.

Further, artificial buoyancy is buoyancy that is generated by applying negative (−) pressure or vacuum to artificially generate buoyancy in a chamber having a predetermined volume (an object having a predetermined chamber).

When the mass per volume of the entire of a chamber having a predetermined volume (an object (fluid) having this chamber) is smaller than the mass of the air having the same volume, that is, the density of the object (fluid) is smaller than the density of the air, buoyancy is generated in the chamber having the volume (the object (fluid) having the chamber).

Therefore, according to an method that can artificially generate buoyancy without using a buoyant substance, when the density of the air is decreased by applying negative (−) pressure or vacuum to a chamber having a predetermined volume (when a portion of the air is removed (by applying negative pressure) or the air is completely removed (by applying vacuum to reduce the number of molecules of the air), the mass of the object (fluid) decreases in the same volume, so a difference is generated between the mass of the air and the mass of the object (fluid) in the same volume and buoyancy is generated as much as the difference, which is artificial buoyancy.

This content is described in more detail.

In order to manufacture the electrical energy transporter 50

such that the total amount of energy that is brought (transported) to a designated electrical energy distribution place through one time of the electricity producing/transporting cycle is larger than the total amount of energy that is used (consumed) through the one electricity producing/transporting cycle to achieve the present disclosure,

the buoyancy of the air that is the force of nature is used, that is, energy that is buoyancy obtained from the air for free is maximally used for most of the driving force of the electrical energy transporter that is one of the important technologies of the atmospheric power generation system of the present disclosure, whereby the energy that is used (consumed) to operate and drive the electrical energy transporter to generate, accumulate, and bring photovoltaic electricity from the sky or space is minimized (made zero). Accordingly, the total energy that is used while the electrical energy transporter goes up to the sky or space, generates and accumulates photovoltaic electricity, and brings (transports) the electricity to a designated electrical energy distribution place is made zero (free), whereby the total amount of the brought (transported) energy is minimized.

To this end, the buoyancy that is energy (force) obtained from nature for free, and is required in the present disclosure means natural force that goes opposite to the gravity of the earth.

In order to appropriately use the buoyancy for the present disclosure,

it is required to obtain most of the force (energy) for the electrical energy transporter to goes up to the sky or space (outer space) against the gravity of the earth,

the force for the electrical energy transporter to generate and store photovoltaic electricity while staying in the sky or space against the gravity of the earth,

the energy for the electrical energy transporter to return to a designated electrical energy distribution place from the sky or space, and

the energy for the electrical energy transporter to operate in other periods, where a large amount of energy consumption is required, or to change directions

from the buoyancy that is free energy obtained from nature.

However, the most effective method of generating buoyancy with a desired magnitude and use it in the present disclosure is to generate a density difference between the electrical energy transporter of the present disclosure and the air to generate buoyancy.

That is, density is a value obtained by dividing the mass of a substance by the volume and buoyancy is force acting opposite to the gravity of the earth and is the same as the mass of an object corresponding to the volume of the object.

Accordingly, it is required to obtain buoyancy required for the electrical energy transporter in the present disclosure and adjust the magnitude of the buoyancy by adjusting a density difference (mass difference) by putting a buoyant substance into the electrical energy transporter (natural buoyancy), artificially applying buoyancy (artificial buoyancy), mounting a separate device for generating buoyancy (buoyant device), or the like such that weight (mass) corresponding to the volume of the electrical energy transporter is smaller than the mass to the same volume of the surrounding air (the density of the electrical energy transporter is smaller than the density of the surrounding air in the same volume).

Arithmetically describing, the buoyancy that is applied to an object is the same as the weight (mass) of substitute fluid for the object.

This is expressed as U=Vμg

where U is buoyancy (N), V is the volume (m³) of the substitute fluid, ρ is the density (kg/m³) of the substitute fluid, and g is a gravitational constant (N/kg).

Consequently, U=W, so the buoyancy is the same as the weight (mass) of the substitute fluid,

where W is the weight (N, mass) of the substitute fluid.

Further, the substitute fluid means all substances existing in the air in the earth except for the air, and in the present disclosure, the substitute fluid means an object to be lifted up in the air, that is, the electrical energy transporter, or a buoyant substance, a buoyant device, or the like that is used to lift up the electrical energy transporter.

Accordingly, it is possible to increase the weight of substitute fluid to be lifted up in the air atmosphere) by the force of nature (force of air pushing up substitute fluid using a density difference) only by increasing buoyancy without separately consuming energy.

That is, when buoyancy is increased, the weight of the electrical energy transporter to be lifted up to the sky is also increased in proportion to the increase of the buoyancy, so it is possible to lift the electrical energy transporter into the air without separate energy.

This is described again in detail with reference to an example.

In order to almost permanently (eternally) produce future energy that enables an almost infinite amount of electrical energy in the most safe and clean method without the limitation of energy exhaustion,

a drone is used as the electrical energy transporter, a photovoltaic power generation facility having capacity that can produce (generate) electricity of 1.6 KWH per hour is installed on the drone (for example, a 100 WH photovoltaic module that is produced and sold by Twinkle power Co., Ltd. in Korea is a flexible product, has a weight of 1.85 kg, dimensions of 3 mm thickness, about 1 m width, and about 0.5 m height, and produces electricity of 100 WH per hour using sunlight. 16 units of this photovoltaic module are installed on the electrical energy transporter in a structure that can receive sunlight well. In this case, the total of weight of the 16 photovoltaic modules is about 30 kg and the total of the electricity that the 16 photovoltaic modules produce (generate) is 1.6 KWH per hour).

Further, an electricity storage device that can store about 50 KWH (KVAH) is installed on the one drone as the photovoltaic electricity storage device (for example, one industrial battery (electricity storage device) of 50 KWH (KVAH) that is produced and sold by Twinkle power Co., Ltd. in Korea can be installed and the weight of the industrial battery is 67 kg).

An electrical circuit is configured such that the electricity produced (generated) by the photovoltaic power generation facility installed on the one drone can be accumulated (stored) in the electricity storage device.

When the drone is flown to the sky, the one drone can produce and store photovoltaic electricity of 1.6 KWH per hour, and when the drone stays for about 31 hours in the sky, the drone can store (accumulate) electricity of total 50 KWH (KVAH) (by continuously following the sun and moving to receive the direct sunlight to be irradiated well by sunlight for 24 hours a day), and can return to a designated electrical energy distribution place.

Further, in this case, assuming that the weight of the drone and the other facilities is about 50 kg, the total weight of the one drone is about 150 kg.

Accordingly, it is assumed that one drone of 150 kg is flown to the sky only by buoyancy in the air without separate energy consumption and helium gas is selected as a buoyant substance, which generates buoyancy in the air, from substances that are smaller in density than the air, and is applied to achieve the objective of this embodiment.

In order to fly (lift or hold) the one drone of this example in the sky using only buoyancy, when a coated chamber is formed in the one drone (assuming that the leakage rate of the helium gas is zero by the coating) such that the chamber is positioned at the center of the center of gravity of the drone and has a volume of 120 m³ or more in the chamber and the volume of the entire one drone is at most 120 m³ or more, and then the chamber is filled up with the helium gas (on the basis of the atmospheric pressure), the drone of this example is gradually moved up to the air (atmosphere) only by the force of nature (air buoyancy). Accordingly, it is possible to achieve the objective of manufacturing one drone of which the total weight is 150 kg, and flying the drone to the sky using only the buoyancy in the air without separate energy consumption.

Verifying this with a formula,

U=W in the buoyancy equation, so the buoyancy is the same as the weight (mass) of the substitute fluid. That is, buoyancy is the force of nature that acts opposite to the gravity of the earth (without separate energy consumption), as described above, the buoyancy is the same as substitute fluid corresponding to the volume of the substitute fluid (an object to be lifted up to the air by the buoyancy), and the gravity of the earth pulls all substances toward the earth and the air of the atmosphere surrounding the earth presses all substance on the earth with pressure of 1 atmospheric pressure (atmospheric pressure).

Accordingly, substances of which the density is smaller than the density of the air (that is, substances lighter than the air in the same volume) (in which density is a value obtained by dividing the mass of a substance by the volume), that is, substances (substitute fluids requiring buoyancy) other than the air are pushed up to the air by the force of the air keeping its position using the force (atmospheric pressure, 1 atmospheric pressure) acting down by the gravity, in which all substitute fluids other than the air stay on the ground as much as the mass per volume (density) due to their weights (mass per volume=density). In this case, buoyancy that pushes up to the air the substitute fluids smaller in mass per volume (density) than the air as much as the difference from the mass per volume (density) of the air is generated. This air buoyancy increases in proportion to the difference between the mass of substitute fluid (which is an object to be lifted up to the air by buoyancy in the present disclosure and is the drone in the above example) and the mass of the air.

Accordingly, when the volume of the drone having the total weight of 150 kg is made at least 120 m³,

since mass (kg)=density (kg/m³)×volume (m³),

air density=1.43 (kg/m³) (density of air at 0° C. and 1 atmospheric pressure),

helium density=0.18 (kg/m³) (density of helium at 0° C. and 1 atmospheric pressure), and

air buoyancy (N)=air mass (kg)−buoyant substance (helium) weight (kg), so air buoyancy (N)=1.43 (kg/m³)−0.18 (kg/m³)=1.25 (kg/m³).

However, the air buoyancy 1.25 (kg/m³) calculated from the above equation means that the helium gas having a volume of 1 m width, 1 m length, and 1 m height has buoyancy of 1.25 kg in the air (at 0° C., 1 atmospheric pressure), and the buoyancy is considered as lifting up a substance (a buoyant substance, helium gas in this example) lighter than the air and having weight of 1.25 kg to the air (atmosphere) as the force of nature (buoyancy).

On the other hand, buoyancy of 150 kg or more is required to lift up the electrical energy transporter of which the total weight is 150 kg to the air.

When the helium gas has a volume of 1 m³, it has buoyancy of 1.25 kg, so 150 kg 1.25 kg=120 to obtain buoyancy of 150 kg.

Accordingly, it is possible to obtain buoyancy of 150 kg by increasing the volume of the helium gas 120 times.

Therefore, the air buoyancy when one drone of which the total weight is 150 kg in the above example is provided with helium gas that is a buoyant substance and has a volume of at least 120 m³

pushes up the one drone of which the total weight is 150 kg to the sky (air) using only the force of nature without separate energy consumption.

Next, after the one drone of the example is pushed up to the sky only by the air buoyancy at an appropriate altitude (where photovoltaic power generation can be performed well), when the buoyancy of the drone is decreased (a portion of the helium gas in the chamber in the drone is discharged to the atmosphere) such that the density of the drone becomes the same as the density of the surrounding air, the drone can stay in the sky using only the air buoyancy without consuming energy.

When the buoyancy is maintained so that the drone stays in the sky (air) only for about 31 hours (while continuously following the sun and moving to receive the direct sunlight to be irradiated well by sunlight for 24 hours a day), the 16 photovoltaic modules mounted on the drone intensively directly sunlight only by the force of nature without separate energy consumption. Accordingly, each of the photovoltaic modules produces electricity of 100 WH for an hour and all the 16 photovoltaic modules produce (generate) electricity a total of 1.6 KWH per hour, whereby a total of 50 KWH (KVAH) is stored (accumulated) for 31 hours in the one industrial battery (electricity storage device) of 50 KWH (KVAH) mounted with the 16 photovoltaic modules on the drone.

Next, the one drone storing (accumulating) electricity of a total of 50 KWH (KVAH) through photovoltaics using only the air buoyancy that is the force of nature without using any energy has only to stop storing electricity and return to a designated electrical energy distribution place (e.g., an electrical energy distribution place at Seoul, Korea).

The drone returns using the gravity of the earth while hardly consuming separate energy.

That is, the helium gas in the drone is discharged to the atmosphere so that the entire density of the drone becomes larger than the density of the surrounding air (the buoyancy of the drone is decreased much or completely removed by discharging a lot of helium gas).

Accordingly, the total density of the drone increases larger than the density of the surrounding air (by the weight of 150 kg), so the drone is naturally moved down (returned) to the designated electrical energy distribution place in Seoul by the gravity of the earth.

As a result, one drone configured as described above to have a weight of 150 kg is operated (driven) between the sky and the designated electrical energy distribution place on the ground only by the air buoyancy that is the force of nature.

Accordingly, it is possible to obtain electricity of a total of 50 KWH (KVAH) completely for free using only the force of nature while hardly consuming separate energy.

That is, by using buoyancy (energy) that is the force (energy) of nature that nature provides for free,

it is possible to make the total amount of electrical energy, which is produced (generated) and brought (transported) to a designated electrical energy distribution place from the sky or space through one time of the electricity producing/transporting cycle, be larger than the total amount of energy that is used (consumed) for one electricity producing/transporting cycle.

The above description is rearranged.

The electrical energy transporter of <Embodiment 1> and <Embodiment 2> should be manufactured

such that the total amount of electrical energy produced (generated) and brought (transported) to a designated electrical energy distribution place from the sky or space through one time of the electricity producing/transporting cycle is larger than the total amount of energy that is used (consumed) through one time of the electricity producing/transporting cycle.

Further, when the electrical energy transporter of <Embodiment 1> and <Embodiment 2> is manufactured

such that the total amount of electrical energy produced (generated) and brought (transported) to a designated electrical energy distribution place from the sky or space through one time of the electricity producing/transporting cycle is larger than the total amount of energy that is used (consumed) through one time of the electricity producing/transporting cycle,

a portion of or the entire of the energy required to operate (drive) the electrical energy transporter should be obtained from the force (energy) of nature,

which is naturally obtained using the principle of nature (or the order of the universe, etc.), while separate energy is hardly used.

In order to obtain a portion of or the entire of the energy required to operate (drive) the electrical energy transporter from the force of nature,

the large amount of energy, which is consumed in any one or more operation periods of when the electrical energy transporter flies to the sky or space, stays in the sky or space, returns to a designated electrical energy distribution place from the sky or space, and is operated (driven) in operating (driving) periods where a large amount of energy is consumed

should be partially or entirely obtained from the force (energy) of nature that is naturally obtained using the principle of nature (or the order of the universe, etc.) while separate energy is hardly used.

Further, it is optimal that the force of nature that is naturally obtained using the principle of nature (or the order of the universe, etc.) without separate energy consumption

is buoyancy in the air that pushes up an object to the air opposite the gravity of the earth.

Further, the buoyancy in the air should be

any one or more of natural buoyancy generated by a buoyant substance and artificial buoyancy generated by applying negative (−) pressure or vacuum to artificially generate buoyancy.

Further, natural buoyancy is

buoyancy that is naturally generated when a chamber having a predetermined volume (an object having a chamber having a predetermined volume) is filled with a buoyant substance.

Further, the buoyant substance is

a substance having density lower than the density of the air.

Further, it is more effective to use any one or more of helium gas, hydrogen gas, methane gas, and hydrogen

that are buoyant substances, which are more easily applied and used for the electrical energy transporter, of buoyant substances having density lower than the density of the air.

Further, artificial buoyancy is buoyancy that is generated by applying negative (−) pressure or vacuum to artificially generate buoyancy in a chamber having a predetermined volume (an object having a chamber having a predetermined volume).

### Embodiment 4

When applying buoyancy in the air to the electrical energy transporter to obtain a portion or most of the energy required to operate (drive) the electrical energy transporter from the force (energy) of nature in Embodiment 3, it is efficient to use any one of more of:

a first method including any one or more of a way that generates natural buoyancy by forming a chamber having a predetermined volume in the electrical energy transporter and filling the chamber with the buoyant substance, a way that generates artificial buoyancy by applying negative pressure (minus pressure) or vacuum to the chamber, and a way that configures a buoyant device having any one of natural buoyancy and artificial buoyancy for the electrical energy transporter;

a second method of separately additionally configuring a buoyant device having any one or more of natural buoyancy and artificial buoyancy for the electrical energy transporter; and

a third method being able to adjust the magnitude of buoyancy generated by any one or more of the chamber having a predetermined volume in the electrical energy transporter, the buoyant device disposed in the electrical energy transporter, and

the buoyant device separately additionally provided the electrical energy transporter in the first method and the second method.

### Embodiment 4-1

The first method including any one or more of the way that generates natural buoyancy by forming a chamber having a predetermined volume in the electrical energy transporter and filling the chamber with the buoyant substance, the way that generates artificial buoyancy by applying negative pressure (minus pressure) or vacuum to the chamber, and the way that configures a buoyant device having any one of the natural buoyancy and artificial buoyancy for the electrical energy transporter is described in more detail.

\textcircled{1} According to the method of generating natural buoyancy by forming a chamber having a predetermined volume in the electrical energy transporter and filling the chamber with the buoyant substance,

a magnitude of buoyancy (buoyancy=weight to be lifted) corresponding to the magnitude of the weight of the electrical energy transporter is required so that the electrical energy transporter has desired weight and is lifted up to the sky or the air only by buoyancy that is the force of nature.

However, the magnitude of buoyancy per unit volume is the magnitude of buoyancy corresponding to the difference obtained by subtracting the mass value of a buoyant substance per unit volume from the mass value of the surrounding air per unit volume.

Accordingly, in order to obtain buoyancy having magnitude corresponding to the magnitude of the weight of the electrical energy transporter, the mass difference between surrounding air and a buoyant substance per volume of 1 m³ is set a buoyancy reference value and a value obtained by dividing the weight value of the electrical energy transporter by the buoyancy reference value is set the volume value of a chamber in which the buoyant substance should be provided.

Thereafter, a chamber having a volume over the volume value of the chamber, in which the buoyant substance should be provided, in the electrical energy transporter and then the buoyant substance is fully put (inject) into the chamber (in which, the injection pressure of the buoyant substance is 1 atmospheric pressure that is the same as the surrounding air pressure).

This method is described in more detail with reference to an embodiment.

As described in <Embodiment 3>,

when an electrical energy transporter having weight of 150 kg is lifted up to the air only by the buoyancy of helium gas,

in the equation, mass (kg)=density (kg/m³)×volume (m³),

air density=1.43 (kg/ms) (density of air at 0° C. and 1 atmospheric pressure) and

helium density=0.18 (kg/ms) (density of helium at 0° C. and 1 atmospheric pressure).

Accordingly, first, when the buoyancy reference value is calculated, the buoyancy reference value (difference of density)=air density−helium density=1.43 (kg/m³)−0.18 (kg/m³)=1.25 (kg/m³).

However, the air buoyancy 1.25 (kg/m³) means that the helium gas having a volume of 1 m width, 1 m length, and 1 m height has buoyancy of 1.25 kg in the air (at 0° C., 1 atmospheric pressure), and the buoyancy is considered as lifting up a substance (a buoyant substance, helium gas in this example) lighter than the air and having weight of 1.25 kg to the air (atmosphere) as the force of nature (buoyancy).

The value of the volume of the chamber in which the buoyant substance (helium gas) should be provided is calculated on the basis of the above factors.

Buoyancy of 150 kg or more is required to lift up the electrical energy transporter having a total weight of 150 kg to the air.

Accordingly, when the helium gas has a volume of 1 m³, it has buoyancy of 1.25 kg, so 150 kg 1.25 kg=120 times to obtain buoyancy of 150 kg.

The helium gas can have buoyancy of 150 kg by increasing the volume of the helium gas 120 times.

Accordingly, the value 120 times calculated above is the value of the volume 120 (m³) of the chamber in which the buoyant substance (helium gas) should be provided in the electrical energy transporter to obtain the magnitude of buoyancy required for lifting up the electrical energy transporter having weight of 150 kg to the sky. When such a chamber having a volume of 120 m³ or more is formed in the electrical energy transporter, the buoyancy of the electrical energy transporter is increased by fully injecting helium gas into the chamber (in which the injection pressure of the helium gas is 1 atmospheric pressure that is the same as the surrounding air pressure), and then the electrical energy transporter is flown to the air, the electrical energy transporter having weight of 150 kg is lifted up to the to sky only by buoyancy (natural buoyancy) that is the force of nature even without separate energy consumption.

\textcircled{2} In the way of generating artificial buoyancy by forming a chamber having a predetermined volume in the electrical energy transporter and then applying negative pressure (minus pressure) or vacuum to the chamber of the first method,

the negative pressure (minus pressure) means that the pressure of the air is the same as or under the atmospheric pressure and the vacuum means a chamber in which any substance does not exist.

However, since it is difficult to make a complete vacuum state, low pressure about 1/1000(10−3) mmHg is usually considered as vacuum and vacuum that we usually say is a high-level decompressed state in which a predetermined container is evacuated (for example, which is the same meaning as that when a vacuum cleaner is exemplified, the state in which the vacuum cleaner does not make a 100% vacuum state, but increases negative pressure by discharging air close to vacuum is expressed as vacuum.

Accordingly, negative pressure and vacuum are the same in that the pressure of air is the atmospheric pressure or less, except for the expression of the units.

For the convenience in the present disclosure, a state in which the pressure of air is the atmospheric pressure or less (low pressure) and the state of the low pressure is small is referred to as negative pressure. Further, in the expression of applying vacuum or negative pressure, when air particles are discharged to make pressure lower than the atmospheric pressure, a state in which a small amount of air is discharged is referred to as negative pressure and a state in which a large amount of air is discharged is referred to as vacuum.

Accordingly, in order for the electrical energy transporter has desired weight and is lifted up to the sky or the air only by buoyancy that is the force of nature, buoyancy (buoyancy=weight to be lifted) corresponding to the magnitude of the weight of the electrical energy transporter is required.

Therefore, in order to generate such buoyancy, as described in detail in \textcircled{1}, the air density is decreased by reducing the number of air particles in the chamber in the electrical energy transporter by applying negative pressure or vacuum to the chamber such that the value obtained by subtracting the mass value to the volume of the chamber in the electrical energy transporter from the mass value per volume of the surrounding air becomes a weight value corresponding to the desired weight of the electrical energy transporter to be lifted up to the air, thereby artificially making a density difference such that the difference between the density of the entire chamber having a predetermined volume in the electrical energy transporter and the density of the surrounding air becomes the weight value of the entire electrical energy transporter.

This method is described in more detail with reference to an embodiment.

As described in detail in <Embodiment 3>, in order to obtain the magnitude of buoyancy required to lift up 150 kg to the sky

when lifting up an electrical energy transporter having weight of 150 kg to the sky using only the buoyancy of helium gas, the number of air particles is discharged out of the chamber by applying negative pressure or vacuum corresponding to the density of the helium gas instead of injecting the helium gas into the chamber that has a volume value of 120 (m³) and in which the helium gas should be provided in the electrical energy transporter. Accordingly, air density corresponding to the density of the helium gas is maintained in the chamber.

That is, as described in detail above in the embodiment of \textcircled{1},

in the equation of mass (kg)=density (kg/m³)×volume (m³),

the air density=1.43 (kg/m³) and the helium density=0.18 (kg/m³) in a closed chamber having a volume

Accordingly, when the density in the chamber is made 0.18 (kg/m³) that is the density of the helium gas (air density in a reference chamber at 0° C. when the atmospheric pressure outside the reference chamber is 1 atmospheric pressure) by decreasing the air density by reducing the number of air particles in the chamber by applying negative pressure or vacuum such that the density in the chamber of the electrical energy transporter becomes the same as the density of the helium gas, the objective can be achieved.

Arithmetically verifying this,

first, when a buoyancy reference value of a closed reference chamber having a volume of 1 m³ (a volume of a width of 1 m, a length of 1 m, and a height of 1 m), buoyancy reference value of reference chamber (a difference in density)=air density−density of reference chamber=1.43 (kg/m³)−0.18 (kg/m³)=1.25 (kg/m³).

That is, the buoyancy reference value 1.25 (kg/m³) of the reference chamber means that a closed chamber having a volume of 1 m width, 1 m length, and 1 m height,

in other words, a volume of 1 m³ has buoyancy of 1.25 kg in the air (at 0° C., 1 atmospheric pressure), and the buoyancy is considered as lifting up a substance having weight of 1.25 kg (a buoyant substance, the electrical energy transporter in this example) to the air (atmosphere) as the force of nature (buoyancy).

Next, in order to generate buoyancy required to light up the electrical energy transporter when the density of a volume of 1 m³ that is the calculated reference chamber is 0.18 (kg/m³), the volume value of the chamber that should be formed in the electrical energy transporter is calculated.

Buoyancy of 150 kg or more is required to lift up the electrical energy transporter of which the total weight is 150 kg to the air.

When the reference value has density of 0.18 (kg/m³) in a volume of 1 m³, buoyancy of 1.25 kg is generated.

Accordingly, 150 kg 1.25 kg=120 times to generate buoyancy of 150 kg.

Therefore, a chamber having a predetermined volume is formed in the electrical energy transporter such that the size thereof is 120 times 1 m³ that is the reference volume, that is, the volume becomes 120 m³.

Then, the air density is decreased by reducing the number of air particles in the chamber by applying negative pressure or vacuum to the entire volume increased to have the volume of 120 m³ such that the density of the entire chamber becomes 0.18 (kg/m³) that is the density of helium gas. As a result, the volume increased to have the volume of 120 m³ has buoyancy of 150 kg.

In this case, when applying negative pressure or vacuum, it is possible to obtain desired negative pressure (or vacuum degree) by discharging the air in the chamber to the outside while adjusting the amount of the air using a facility or a device (e.g., a vacuum pump) that generates negative pressure or vacuum in the chamber having the volume calculated above.

Consequently, the value 120 times of the reference chamber means that the volume value of the entire chamber, in which the air density is made 0.18 (kg/m³) by applying negative pressure or vacuum to the chamber of the electrical energy transporter for obtaining the magnitude of buoyancy required to lift up the weight 150 kg of the electrical energy transporter to the sky, is 120 (m³). Further, when the chamber having a volume of 120 m³ or more in which negative pressure or vacuum is made such that the air density therein is 0.18 (kg/m³) is positioned at the center of gravity of the electrical energy transporter and then the electrical energy transporter is flown to the air, the electrical energy transporter having weight of 150 kg is lift up to the sky only by buoyancy (artificial buoyancy) that is the force of nature even without separate energy consumption.

\textcircled{3} In the first method, the way of installing a buoyant device manufactured to have any one or more natural buoyancy and artificial buoyancy in the electrical energy transporter

is to generate buoyancy in any one or a way of manufacturing a close object having a predetermined (desired) volume to have natural buoyancy as in \textcircled{1} and a way of manufacturing the object to have artificial buoyancy as in \textcircled{2} separately from the electrical energy transporter, and then dispose the object in a chamber in which the center of gravity of the electrical energy transporter can be positioned at the center thereof.

The way of generating buoyancy in the buoyant device and the detailed way of increasing buoyancy are the same as the way of generating natural buoyancy in \textcircled{1} and the way of generating artificial buoyancy in \textcircled{2}, so they are not described in detail herein.

### Embodiment 4-2

The second method of separately additionally configuring a buoyant device having any one or more of the natural buoyancy and artificial buoyancy in the electrical energy transporter is described in more detail.

The second method is to generate buoyancy in any one or more of the method of generating buoyancy in an object having a closed chamber having a predetermined (desired) volume as in \textcircled{1} and the method of generating artificial buoyancy in the object as in \textcircled{2}, separately from the electrical energy transporter, and then separately additionally provide the object outside the electrical energy transporter such that the center of gravity can be positioned at the center.

The buoyant device that is separately additionally provided for the electrical energy transporter is used to further increase, distribute, or adjust the buoyancy of the electrical energy transporter.

This method is described in more detail with reference to an embodiment.

As described in the embodiment of the first method, in order to lift up an electrical energy transporter having weight of 150 kg to the sky using only buoyancy,

the balloon has buoyancy of about 50 kg (the calculation formula follows the first method), when a balloon is prepared as the separate buoyant device, the volume of the inside of the balloon is made 40 m³, and then the balloon is fully filled with helium gas (at the same pressure as the surrounding air pressure).

When the balloon having buoyancy of 50 kg is connected to the electrical energy transporter such that the center of gravity is positioned at the center, the total buoyancy of the electrical energy transporter 200 kg because the buoyancy of the buoyant device 50 kg is added to 150 kg of the main body. Further, when the electrical energy transporter is flown to the air, it is lifted up to the air at a speed as fast as the added buoyancy 50 kg of the buoyant device.

That is, using a balloon that is a separate buoyant device consequently further increases buoyancy.

Further, when helium gas is discharged from the balloon that is a separate buoyant device (a fastened rope is loosened by a remote controller so that the balloon is separated from the electrical energy transporter) after the electrical energy transporter goes up to an appropriate position for photovoltaics in the air, the electrical energy transporter loses buoyancy of 50 kg and stops at the appropriate position in the air (stops as a position where the air density and the total density of the electrical energy transporter are made equilibrium).

That is, using a balloon that is a separate buoyant device consequently adjusts buoyancy.

Further, a method of distributing necessary buoyancy of the electrical energy transporter under another condition in the above example is described.

Assuming that the weight of the electrical energy transporter to be lifted up to the air is 150 kg and the volume of the main body of the electrical energy transporter should be made 40 m³, that is, should be decreased to ⅓ of the above example,

when two helium gas balloons each having a volume of 40 ms and fully filled with helium gas (at 0° C., 1 atmospheric pressure) are connected to the electrical energy transporter having weight of 150 kg such that the centers of gravity are positioned at the center), the main body of the electrical energy transporter has buoyancy of only 50 kg, but the separately additionally provided two helium gas balloons each add buoyancy of 50 kg, whereby the actual total buoyancy of the electrical energy transporter is 150 kg. Accordingly, it is possible to lift the main body of the electrical energy transporter having weight of 150 kg to the sky as intended without any problem.

That is, using a balloon that is a separate buoyant device consequently distributes buoyancy.

### Embodiment 4-3

The third method being able to adjust the magnitude of buoyancy generated by any one or more of the chamber having a predetermined volume in the electrical energy transporter, the buoyant device disposed in the electrical energy transporter, and the buoyant device separately additionally provided the electrical energy transporter is described in more detail.

The third method being able to adjust the magnitude of buoyancy

generated by the chamber having a predetermined volume in the electrical energy transporter, the buoyant device disposed in the electrical energy transporter, and the buoyant device separately additionally provided the electrical energy transporter can perform

any one or more of a way of adjusting the pressure in a chamber generating buoyancy and a way of adjusting the volume of the chamber.

This method adjusts the magnitude of buoyancy using any one or more of:

a first method that generates natural buoyancy in any one or more of a chamber having a predetermined volume in the electrical energy transporter, a buoyant device disposed in the electrical energy transporter, and a buoyant device separately additionally provided for the electrical energy transporter such that any one or more of the pressure and volume of a buoyant substance used in this case can be adjusted, and that increases, reduces, or distributes of the entire buoyancy of the electrical energy transporter by adjusting any one or more of the pressure and the volume of the buoyant substance; and

a second method that generates artificial buoyancy in any one of a chamber having a predetermined volume in the electrical energy transporter, a buoyant device disposed in the electrical energy transporter, and a buoyant device separately additionally provided for the electrical energy transporter such that any one or more of negative pressure used in this case or pressure for applying vacuum and the volume of a chamber to which the negative pressure and vacuum is applied, and that increases, reduces, or distributes of the entire buoyancy of the electrical energy transporter by adjusting any one or more of the negative pressure and pressure corresponding to a vacuum state of the chamber,

to which negative pressure and vacuum is applied, and the volume of the chamber.

### Embodiment 4-3-1

The first embodiment of <Embodiment 4-3> is described in more detail.

The volume of gas is proportioned to pressure at a constant temperature (Boyle's law).

Accordingly, if a buoyant substance (helium gas, hydrogen gas, etc.) is injected at prepared (injecting) pressure the same as the surrounding air pressure in the first method and the second method in <Embodiment 4> when a buoyant substance is prepared to generate natural buoyancy in the electrical energy transporter or a separate buoyant device,

the third method performs any one or more of injecting the buoyant substance such that the prepared (injecting) pressure is higher than the surrounding air pressure and

of increasing the injection volume of the buoyant substance (larger than the volume value calculated from the calculation methods in <Embodiment 4-1> and <Embodiment 4-2>.

Then, the third method adjusts the magnitude of the buoyancy of the electrical energy transporter or the separate buoyant device by adjusting any one of the increased pressure and volume of the buoyant substance.

In other words,

a method of more effectively performing the first method of <Embodiment 4-3> performs any one or more of:

a way of increasing the pressure of a buoyant substance, which is injected to generate buoyancy in any one or more of a chamber having a predetermined volume in the electrical energy transporter, a buoyant device disposed in the electrical energy transporter, and a buoyant device separately additionally provided for the electrical energy transporter, larger than the surrounding air pressure; and

a way of increasing the volume of a chamber in which a buoyant substance is provided to increase the buoyancy of any one or more of the chamber having a predetermined volume in the electrical energy transporter, the buoyant device disposed in the electrical energy transporter, and the buoyant device separately additionally provided for the electrical energy transporter (larger than the volume value calculated from the calculation methods in <Embodiment 4-1> and <Embodiment 4-2>, and then

adjusts the magnitude of the buoyancy by adjusting (changing) any one or more of the pressure of the buoyant substance or the volume of the chamber in which the buoyant substance is provided.

### Embodiments 4-3-1-1

In <Embodiment 4-3-1>

the method of adjusting the magnitude of the buoyancy by adjusting (changing) any one or more of the pressure of the buoyant substance or the volume of the chamber in which the buoyant substance is provided is described in more detail with reference to an embodiment.

First, the method of adjusting the magnitude of buoyancy by increasing the pressure of a buoyant substance larger than the surrounding air pressure in <Embodiment 4-3-1> is described in detail.

When the electrical energy transporter having weight of 150 kg is flown to the sky using only buoyancy in <Embodiment 4-1>,

a chamber having a volume of 120 m³ is formed in the electrical energy transporter, buoyancy of the electrical energy transporter is increased by fully injecting helium gas into the chamber (in which the injection pressure of the helium gas is 1 atmospheric pressure that is the same as the surrounding air pressure), and then the electrical energy transporter is flown to the air. Accordingly, the electrical energy transporter having weight of 150 kg is flown to the sky by only the buoyancy (natural buoyancy) that is the force of nature even without separate energy consumption.

However, it is assumed in <Embodiment 4-1> that when helium gas that is a buoyant substance is injected into the chamber having a volume of 120 m³, the injected pressure is the same as the surrounding air pressure (atmospheric pressure).

However, the pressure in the chamber filled with the buoyant substance (helium gas) is larger than the surrounding air pressure (atmospheric pressure), and when the pressure of the chamber filled with the buoyant substance is increased, the density is also increased in proportion to the pressure and the buoyancy is decreased. Accordingly, in order to compensate for the buoyancy, the volume of the chamber in which the buoyant substance is injected is increased and the buoyant substance is injected into the increased chamber.

That is, this method is compared with the method in the embodiment in <Embodiment 4-1>.

The method in the embodiment in <Embodiment 4-1> making the volume of the inside of the electrical energy transporter or a separately provided buoyant device as 120 m³ and fully fill the inside with a buoyant substance (helium gas) at the atmospheric pressure the same as the surrounding air pressure in order to lift the electrical energy transporter having weight of 150 kg to the sky using only buoyancy.

However, this method increases the volume of the chamber larger than 120 m³ and maintains the pressure in the chamber higher than the surrounding air pressure (atmospheric pressure) by increasing the pressure of the buoyant substance (helium gas) injected in the chamber (increases the number of particles of the buoyant substance larger than that in the atmospheric pressure) such that the density of the buoyant substance (helium gas) in the chamber is larger than 0.18 (kg/m³) and the entire buoyancy is 150 kg or more.

According to this method, as compared with the method in <Embodiment 4-1>, the chamber that is filled with a buoyant substance in the electrical energy transporter is increased larger than 120 m³, the pressure in the chamber filled with the buoyant substance is increased larger than the surrounding atmospheric pressure, and the entire buoyancy is 150 kg or more.

Further, when the electrical energy transporter is flown to the sky and discharges the buoyant substance out of the chamber, potential buoyancy that additionally increases the buoyancy is generated. Accordingly, the electrical energy transporter has spare buoyancy that enables the electrical energy transporter to adjust the buoyancy when the electrical energy transporter goes up to the sky, stays in the sky, or goes down (remaining energy corresponding to the number of particles of the buoyant substance and being able to discharge the buoyant substance out of the chamber).

This is arithmetically verified again.

Since air density=1.43 (kg/m³) and helium density=0.18 (kg/m³),

mass (kg)=density (kg/m³)×volume (m³), density=mass÷volume,

the relationship between pressure and volume in Boyle's law, P=K×1/V (P is pressure, K is proportional constant, and V is volume), and

when the volume is 1 m³, helium gas has weight (mass) of 0.18 kg, but when the volume is increased twice, density (kg/m³)=mass÷volume=0.18 kg÷2 m³=0.09 kg/m³, so it can be seen that the density decreases in inverse proportion to the volume.

Further, when helium gas is injected in a chamber having a volume of 1 m³ at 1 atmospheric pressure (atmospheric pressure) and then the pressure of the chamber that is maintained at 1 atmospheric pressure is increased twice to 2 atmospheric pressure, K=2P÷½V because the proportional constant, so it can be seen that the volume decreases in inverse proportion to the pressure.

Since density decreases in inverse proportion to volume and volume decreases in inverse proportion to pressure, density=1/volume, volume=1/pressure, and density=1÷1/pressure=pressure, so it can be seen that density increases or decreases in proportion to pressure.

In order to arithmetically verify this method,

the volume of the chamber in an electrical energy transporter having weight of 150 kg is 120 m³ and the chamber is filled with helium gas at 1 atmospheric pressure such that buoyancy of 150 kg is generated, but when the volume of the chamber,

for example, is increased twice to 240 m³ in this method (in which helium gas is additionally injected such that the pressure in the chamber becomes 1 atmospheric pressure), the formula described above in <Embodiment 4-1> becomes buoyancy reference value (difference in density)=air density−density of reference chamber=1.43 (kg/m³)−0.18 kg/m³=1.25 (kg/m³). Further, by multiplying the formula by the increased volume, total buoyancy=1.25 (kg/m³)×240 m³=300 kg, that is, the buoyancy is increased twice.

In this state, when the pressure in the chamber increased twice is increased 4.47 times to 4.47 atmospheric pressure, the density of the helium gas in the chamber increased twice is also increased 4.47 times because it can be seen that density is proportioned to pressure in the above formula.

This is expressed as a formula of helium density at 4.47 atmospheric pressure=0.18 (kg/m³)×4.47=0.80 (kg/m³).

Further, the formula described above in <Embodiment 4-1> becomes buoyancy reference value (difference in density)=air density−density of reference chamber=1.43 (kg/m³)−0.80 kg/m³=0.63 (kg/m³). By multiplying this formula by the volume, total buoyancy=0.63 (kg/m³)×240 m³=151 kg, so the buoyancy becomes 151 kg that is almost the same as that in <Embodiment 4-1>.

As a result, the method in the embodiment in <Embodiment 4-1> making the volume of the inside of the electrical energy transporter or a separately provided buoyant device as 120 m³ and fully fill the inside with a buoyant substance (helium gas) at the atmospheric pressure the same as the surrounding air pressure in order to lift the electrical energy transporter having weight of 150 kg to the sky using only buoyancy.

However, this method increases the volume of the chamber (to 240 m³) larger than 120 m³ and maintains the pressure in the chamber higher than the surrounding air pressure (atmospheric pressure) by increasing the pressure of the buoyant substance (helium gas) injected in the chamber (to 4.47 atmospheric pressure) (increases the number of particles of the buoyant substance 4.47 times that in the atmospheric pressure) such that the density of the buoyant substance (helium gas) in the chamber is larger than 0.18 (kg/m³) and the entire buoyancy is 150 kg or more.

As described above, after an electrical energy transporter with the volume and the pressure in the chamber increased or a separately provided buoyant device is flown to the sky, when the buoyancy gradually decreases due to the pressure of the surrounding air that decreases as the altitude increases, the internal pressure of the air is decreased in proportion to the decreasing surround air pressure by gradually discharging the buoyant substance stored with the pressure of the air increased to the outside of the chamber. Accordingly, the buoyancy of the electrical energy transporter or the separately provided buoyant device can be adjusted to the ideal buoyancy that is the same as that when the electrical energy transporter or the buoyant device starts to be flown to the sky. Therefore, it is possible to adjust the buoyancy by reducing the pressure inside the electrical energy transporter or the separately provided buoyant device in the sky.

### Embodiments 4-3-1-2

Next, the method of adjusting the magnitude of buoyancy by increasing the volume of a chamber in which a buoyant substance is provided (larger than the volume value calculated in the calculation methods described in <Embodiment 4-1> and <Embodiment 4-2>) in <Embodiment 4-3-1> is described in detail.

A device such as a balloon of which the volume is maintained or slightly increased when pressure is applied and is completely decreased when pressure is removed is separately prepared as a separately provided buoyant device for the energy transporter. When a buoyant substance stored in the device under pressure is discharged after the electrical energy transporter is flown to the sky, the volume of the buoyant device is removed. Accordingly, the volume of the entire electrical energy transporter decreases as much as the removed buoyant device, so the buoyancy decreases when only the volume decreases under the same condition that as a volume decreases, there is no change in weight (since density=mass÷volume, in the state in which weight is the same, as described above, when a volume decreases, density increases, and as density increases, buoyancy decreases).

As a result, it is possible to adjust buoyancy by adjusting a volume.

### Embodiment 4-4

According to a combination of <Embodiment 4-1>-<Embodiment 4-3> described above,

it can be seen that the most effective method of generating (forming) buoyancy in any one or more of a chamber having a predetermined volume in the electrical energy transporter, a buoyant device disposed in the electrical energy transporter, and a buoyant device separately additionally provided for the electrical energy transporter

is a method of generating (forming) buoyancy

by decreasing the mass per volume of the chamber (in which a buoyant substance is provided, or negative pressure or vacuum is generated) or gas (a buoyant substance, air, or the like) in the chamber smaller than the mass to the same volume of the surrounding air.

Further, it can be seen that a more effective method of generating (forming) buoyancy by decreasing the mass per volume of the chamber (in which a buoyant substance is provided, or negative pressure or vacuum is generated) or gas (a buoyant substance, air, or the like) in the chamber smaller than the mass to the same volume of the surrounding air

is a method of decreasing the mass per volume of the chamber of a buoyant device smaller than the mass to the same volume of the surrounding air by any one or more of inserting (injecting) a buoyant substance into an object having a closed chamber having a predetermined volume, applying negative pressure (minus pressure) to the object, and applying vacuum to the object.

Further, the buoyant device

should be an object having a closed chamber having a predetermined volume and having a mass per volume smaller than a mass to the same volume of the surrounding air to be able to generate the effect of buoyancy in the sky (air).

### Embodiment 5

The electrical energy transporter of <Embodiment 3> is manufactured

such that the total amount of electrical energy produced (generated) and brought (transported) to a designated electrical energy distribution place from the sky or space through one time of the electricity producing/transporting cycle is larger than the total amount of energy that is used (consumed) through one time of the electricity producing/transporting cycle.

Another method having an additional technology in the method described above in <Embodiment 3> uses any one of more of:

a first method that: obtains a portion of or the entire of a large amount of energy, which is required in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed

from the force (energy) of nature naturally obtained using the principle of nature (or the order of the universe, etc.) while separate energy is hardly used; and

increases the time for which the electrical energy transporter stays in the sky or space such that the amount of production (generation) of photovoltaic electricity is sufficiently increased while the electrical energy transporter goes up to or stays in the sky or space, a sufficiently large amount of electricity is stored (accumulated) in the electricity storage device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a second method that: obtains a portion of or the entire of a large amount of energy, which is required in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed

from the force (energy) of nature naturally obtained using the principle of nature (or the order of the universe, etc.) while separate energy is hardly used; and

increases the buoyancy of the electrical energy transporter such that the capacities of a photovoltaic power generator and an electricity storage device mounted on the electrical energy transporter are increased, the amount of production (generation) of photovoltaic electricity is sufficiently increased while the electrical energy transporter goes up to or stays in the sky or space, or return to a designated electrical energy distribution place, a sufficiently large amount of electricity is stored (accumulated) in the electricity storage to device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a third method that: obtains a portion of or the entire of a large amount of energy, which is required in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed

from the force (energy) of nature naturally obtained using the principle of nature (or the order of the universe, etc.) while separate energy is hardly used; increases the buoyancy of the electrical energy transporter such that the capacities of a photovoltaic power generator and an electricity storage device mounted on the electrical energy transporter are increased; and

increases the time for which the electrical energy transporter stays in the sky or space such that the amount of production (generation) of photovoltaic electricity is sufficiently increased while the electrical energy transporter goes up to or stays in the sky or space, or return to a designated electrical energy distribution place, a sufficiently large amount of electricity is stored (accumulated) in the electricity storage device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a fourth method that: uses any one or more of electrical energy stored (accumulated) in advance in an electricity storage device mounted on the electrical energy transporter, electrical energy newly stored (accumulated) when the electrical energy transporter carries electrical energy (or stays in the sky or space, jet-fuel prepared in advance, and other various kinds of pre-prepared aircraft fuel that is used for flying aircrafts

for a portion of or the entire of a large amount of energy, which is required in any one or more of operating periods of

when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed; and

obtains the other energy to be consumed from the force (energy) of nature naturally obtained using the principle of nature (or the order of the universe, etc.)

such that the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a fifth method that: uses any one or more of electrical energy stored (accumulated) in advance in an electricity storage device mounted on the electrical energy transporter, electrical energy newly stored (accumulated) when the electrical energy transporter carries electrical energy (or stays in the sky or space, jet-fuel prepared in advance, and other various kinds of pre-prepared aircraft fuel that is used for flying aircrafts

for a portion of or the entire of a large amount of energy, which is required in any one or more of operating periods of

when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed;

obtains the other energy to be consumed from the force (energy) of nature naturally obtained using the principle of nature (or the order of the universe, etc.); and

increases the time for which the electrical energy transporter stays in the sky or space such that the amount of production (generation) of photovoltaic electricity is sufficiently increased while the electrical energy transporter goes up to or stays in the sky or space, a sufficiently large amount of electricity is stored (accumulated) in the electricity storage device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a sixth method that: uses any one or more of electrical energy stored (accumulated) in advance in an electricity storage device mounted on the electrical energy transporter, electrical energy newly stored (accumulated) when the electrical energy transporter carries electrical energy (or stays in the sky or space, jet-fuel prepared in advance, and other various kinds of pre-prepared aircraft fuel that is used for flying aircrafts, for a portion of or the entire of a large amount of energy, which is required in any one or more of operating periods of

when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed;

obtains the other energy to be consumed from the force (energy) of nature naturally obtained using the principle of nature (or the order of the universe, etc.); and

increases the buoyancy of the electrical energy transporter such that the capacities of a photovoltaic power generator and an electricity storage device mounted on the electrical energy transporter are increased, the amount of production (generation) of photovoltaic electricity is sufficiently increased while the electrical energy transporter goes up to or stays in the sky or space, or return to a designated electrical energy distribution place,

a sufficiently large amount of electricity is stored (accumulated) in the electricity storage device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

a seventh method that: uses any one or more of electrical energy stored (accumulated) in advance in an electricity storage device mounted on the electrical energy transporter, electrical energy newly stored (accumulated) when the electrical energy transporter carries electrical energy (or stays in the sky or space, jet-fuel prepared in advance, and other various kinds of pre-prepared aircraft fuel that is used for flying aircrafts

for a portion of or the entire of a large amount of energy, which is required in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed;

obtains the other energy to be consumed from the force (energy) of nature naturally obtained using the principle of nature (or the order of the universe, etc.);

increases the buoyancy of the electrical energy transporter such that the capacities of a photovoltaic power generator and an electricity storage device mounted on the electrical energy transporter are increased; and

increases the time for which the electrical energy transporter stays in the sky or space such that the amount of production (generation) of photovoltaic electricity is sufficiently increased while the electrical energy transporter goes up to or stays in the sky or space, or return to a designated electrical energy distribution place, a sufficiently large amount of electricity is stored (accumulated) in the electricity storage device by the increased amount of produced electricity, and the amount of electricity produced (generated) and brought (transported) to a designated electrical energy distribution place from the sky or space through one time of the electricity producing/transporting cycle is larger than the total amount of energy that is used (consumed) through one time of the electricity producing/transporting cycle;

an eighth method that additionally reduces the weight of any one or more of the body of the electrical energy transporter, an assembly of other facilities or frames, and prepared objects in the first method to the seventh method,

thereby minimizing energy that is required in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed;

a ninth method that further configures (mounts) the photovoltaic electricity generator that is mounted on a main body of the electrical energy transporter to occupy small area when being first started on the electrical energy transporter from a designated electrical energy distribution place and to have a large area for photovoltaics when actually starting photovoltaics in the sky or space (e.g., a foldable photovoltaic module, etc.) in the first method to the seventh method such that when the electrical energy transporter is started first from a designated electrical energy distribution place, the area is small (with the foldable photovoltaic module folded), and energy consumption is minimized (or is completely zero using only buoyancy)

by minimizing air resistance when the electrical energy transporter goes up to the sky or space; an area of a photovoltaic facility receiving sunlight is increased (e.g., the foldable photovoltaic module maximally deployed) when the electrical energy transporter starts photovoltaics in the sky or space; and the area of the photovoltaic facility is decreased (e.g., the foldable photovoltaic module folded) when the electrical energy transporter returns to a designated electrical energy distribution place after finishing photovoltaics, thereby minimizing air resistance and accordingly minimizing energy consumption in any one or more of operating periods of when the electrical energy transporter flies to the sky or space, when the electrical energy transporter stays in the sky or space, when the electrical energy transporter returns to a designated electrical energy distribution place, and when the electrical energy transporter is operated (driven) in an operating (driving) period in which a large amount of energy is consumed; and

a tenth method that uses a combination of the first method to the ninth method.

### Embodiment 6

There is an application method for actually implementing a method that

obtains a portion of or the entirety of the large amount of energy, which is consumed in any one or more operation periods of when the electrical energy transporter flies to the sky or space, stays in the sky or space, returns to a designated electrical energy distribution place from the sky or space, and is operated (driven) in operating (driving) periods where a large amount of energy is consumed,

from buoyancy in the air that pushes up an object opposite the gravity of the earth which is the force (energy) of nature that is naturally obtained using the principle of nature (or the order of the universe, etc.) while separate energy is hardly used,

through the method of obtaining a portion of or the entire of the energy required to operate (drive) the electrical energy transporter from the force of nature.

First, the method that is actually applied when flying the electrical energy transporter to the sky or the air has to decrease the density of the entire electrical energy transporter smaller than the density of the surrounding air

while the electrical energy transporter goes up to the sky or space.

To this end, the buoyancy that is generated by any one or more of a chamber or a buoyant device disposed in the electrical energy transporter to generate buoyancy, or a separately provided buoyant device is increased, thereby decreasing the density of the entire electrical energy transporter smaller than the density of the surrounding air while the electrical energy transporter goes up to the sky or space.

Further, in order to increase the buoyancy that is generated by any one or more of a chamber or a buoyant device disposed in the electrical energy transporter to generate buoyancy, and a separately provided buoyant device,

any one or more of the volume of the chamber in which buoyancy is generated and the pressure inside any one or more of the chamber or the buoyant device disposed in the electrical energy transporter to generate buoyancy, and the separately provided buoyant device are adjusted, thereby increasing the magnitude of the buoyancy.

Second, the method that is actually applied when the electrical energy transporter stays in the sky or the air has to maintain the density of the entire electrical energy transporter at the same level as the density of the surrounding air

while the electrical energy transporter goes up to the sky or space.

To this end, the buoyancy that is generated by any one or more of a chamber or a buoyant device disposed in the electrical energy transporter to generate buoyancy, and a separately provided buoyant device is decreased (reduced), and adjustment of the buoyancy is stopped when the density of the entire electrical energy transporter becomes the same as the density of the surrounding air, thereby making the density of the entire electrical energy transporter the same as the density of the surrounding air while the electrical energy transporter stays in the sky or space.

Further, in order to decrease (reduce) the buoyancy that is generated by any one or more of the chamber or the buoyant device disposed in the electrical energy transporter to generate buoyancy, and the separately provided buoyant device, and in order to stop adjusting the buoyancy when the density of the entire electrical energy transporter becomes the same as the density of the surrounding air,

a method that decreases (reduces) any one or more of the volume of the chamber in which buoyancy is generated and the pressure generated in any one or more of the chamber or the buoyant device disposed in the electrical energy transporter to generate buoyancy, and the separately provided buoyant device, and stops decreasing (reducing) any one or more of the pressure and the volume of the chamber in which buoyancy is generated when the density of the entire electrical energy transporter becomes the same as (coincide with) the density of the surrounding air (when the electrical energy transporter stops going up) is used.

Third, the application method when the electrical energy transporter returns to a designated electrical energy distribution place from the sky or space

has to increase the density of the entire electrical energy transporter larger than the density of the surrounding air while the electrical energy transporter returns to the designated electrical energy distribution place from the sky or space.

To this end, the buoyancy that is generated by any one or more of a chamber or a buoyant device disposed in the electrical energy transporter to generate buoyancy, and a separately provided buoyant device is decreased (reduced), and the density of the entire electrical energy transporter is increased larger than the density of the surrounding air, thereby making the density of the entire electrical energy transporter larger than the density of the surrounding air while the electrical energy transporter returns to a designated electrical energy distribution place from the sky or space.

Further, in order to make the density of the entire electrical energy transporter larger than the density of the surrounding air while the electrical energy transporter returns to a designated electrical energy distribution place from the sky or space by decreasing (reducing) the buoyancy that is generated by any one or more of a chamber or a buoyant device disposed in the electrical energy transporter to generate buoyancy, and a separately provided buoyant device,

a method that enables the electrical energy transporter to returns to the designated electrical energy distribution place from the sky or space while freely falling due to the earth's gravity by decreasing (reducing) the buoyancy that is generated by any one or more of the chamber or the buoyant device disposed in the electrical energy transporter to generate buoyancy, and the separately provided buoyant device is used.

### Embodiment 7

When the electrical energy transporter is flown to the sky or space in <Embodiment 1> to <Embodiment 6>,

the surrounding pressure that is applied to the electrical energy transporter gradually decreases as the altitude increases, or the applied pressure becomes zero (vacuum) in the outer space because the air density decreases as the altitude increases or there is no air in a vacuum state in the outer space. Accordingly, the pressure that is applied from the outside to all of a chamber having a predetermined volume in the electrical energy transporter, a buoyant device disposed in the electrical energy transporter, and a buoyant device separately additionally provided for the electrical energy transporter decreases or becomes zero.

Therefore, the internal spaces are increased by expansion of internal air and the volumes of the internal spaces are increased by expansion of the internal spaces, whereby the density of the entire electrical energy transporter is decreased (reduced). Further, as this phenomenon becomes severe (the altitude increases), the density of the entire electrical energy transporter becomes smaller than the density of the surrounding air, so the electrical energy transporter stops going up to the sky or space.

Further, when this phenomenon becomes severe (the altitude increases), all of the chamber having a predetermined volume in the electrical energy transporter, the buoyant device disposed in the electrical energy transporter, and the buoyant device separately additionally provided for the electrical energy transporter maximally expand and blow up, the buoyancy therein is suddenly removed, and only the earth's gravity acts on the electrical energy transporter as a force that pulls down an object to the ground, whereby the electrical energy transporter freely falls from the sky or space. As a result, a problem that it is impossible to achieve the objective of the present disclosure for producing (generating) electricity in the sky or space is caused.

Accordingly, in order to solve the problem,

there is a need for a technology that form any one or more of the chamber having a predetermined volume in the electrical energy transporter, the buoyant device disposed in the electrical energy transporter, and the buoyant device separately additionally provided for the electrical energy transporter such that the volumes of the internal spaces do not expand (hardly or slightly expand) even though the pressure of the surrounding air drops or become zero (vacuum state) in the sky or space.

Further, a structure (thickness, strength, tension, etc.) that resists negative pressure (minus pressure) or vacuum is required in the technology and a substance that can implement the technology should be used as a material.

Further, as the material of the substance that can implement the technology, any one or more of metal, a metal alloy, and special metal that resist negative pressure or vacuum should be used.

In other words,

there is a need for a technology that forms any one or more of a chamber having a predetermined volume in the electrical energy transporter, a buoyant device disposed in the electrical energy transporter, and a buoyant device separately additionally provided for the electrical energy transporter

such that the volumes of the internal spaces do not expand (hardly or slightly expand) even though the pressure of the surrounding air drops or become zero (vacuum state) in the sky or space

in order to prevent the chamber having a predetermined volume in the electrical energy transporter, the buoyant device disposed in the electrical energy transporter, and the buoyant device separately additionally provided for the electrical energy transporter from expanding as they goes up to the sky or space.

Further, a structure (thickness, strength, tension, a lattice structure, etc.) that resists negative pressure (minus pressure) or vacuum is required in the technology and a substance that can implement the technology should be used as a material.

Further, as the material of the substance that can implement the technology, any one or more of metal, a metal alloy, a special material, and a composite material that resist negative pressure or vacuum should be used.

Further, copper, carbon steel, and titanium are used as the metal.

Further, stainless steel and a lithium-magnesium alloy are used as the metal alloy.

A carbon fiber composite material fabricated by mixing metal, ceramic, and polymer matrix in a carbon fiber is used as the composite material.

Further, duralumin is used as the special material.

### Embodiment 8

When the electrical energy transporter is flown to the sky or space in <Embodiment 1> to <Embodiment 6>,

it is required to solve that problem that an electricity storage device mounted on the electrical energy transporter is naturally discharged as it comes into a sub-zero range in which surrounding air temperature is low.

The electricity storage device mounted on the electrical energy transporter includes a battery (lithium ions, etc.) therein that has a function of storing (accumulating) electricity and exhausting (discharging) electricity. The performance of the battery decreases to about 50% in a sub-zero range (natural discharging). Further, when temperature drops under sub-zero 15 degrees Celsius ((−15° C.), natural discharging rapidly increases, so the ability of storing (accumulating) electricity is lost.

Accordingly, in order to solve this problem, it is required to maintain the temperature of the electricity storage device at a temperature (room temperature) such that the performance of the battery is not decreased, by winding an electric heating wire on the electricity storage device.

Further, sine the electricity storage device is designed to be used in the sky or space, the electric heating wire should generate heat using electricity supplied from the electricity storage device.

Further, since the electricity supplied from the electricity storage device is DC electricity and is low-voltage electricity (usually at voltage of 24V or less), the heating wire should be operated by electricity of a battery.

Accordingly, a heating wire that is the most suitable for the heating line may be an assembly-type heating wire that is operated by electricity of a battery.

### Embodiment 9

A method of enabling humans to almost infinitely and almost permanently produce (generate) electricity (energy) that is clean energy obtained by photovoltaics as substitute energy for fossil fuels using the atmospheric power generation system of the present disclosure in the future is described hereafter in more detail.

To this end, an example 2 is described.

First, assuming that one of the designated electrical energy delivery places 30 in <Embodiment 1> is a Seoul electrical energy delivery station on the ground in Seoul of Korea, a drone is selected as the electricity energy transporter that reciprocates between the sky and the Seoul electrical energy delivery station and then a solar cell is installed on the drone to receive sunlight well in the sky (e.g., a foldable solar module is installed to be folded when going up to the sky from the ground and is then unfolded to face the sun in the sky to be able to receive more direct sunlight through a larger area).

Further, an energy storage system (ESS) is further installed on the drone as the electricity storage system that can perform well the function of storing (accumulating) and transporting energy produced (generated) by the solar cell on the drone to the Seoul electrical energy delivery station on the ground and the function of transmitting (discharging or delivering) well the stored (accumulated) electricity at the Seoul electrical energy delivery station.

When the drone goes up to the sky and deploys the foldable solar cell, electricity starts to be produced (generated) and the produced (generated) electricity is stored in the energy storage system (ESS) installed on the drone. When the electricity is sufficiently stored (accumulated) in the energy storage system (ESS) by the capacity, the drone comes down to the Seoul electrical energy delivery station on the ground, discharges the electricity stored (accumulated) in the sky to a large-capacity electricity storage system (an energy storage system (ESS) having large capacity) installed at the Seoul electrical energy delivery station to transmit electricity (charges the large-capacity electricity storage system), and then repeats going up to the sky and storing electricity again and then coming down to the charging station on the ground and discharging the electricity. The electricity stored in this way in the large-capacity electricity storage system installed at the Seoul electrical energy delivery station on the ground is transmitted, distributed, or sent to customers requiring energy (electricity) on the ground.

This is described in more detail with reference to a more detailed example.

A drone is used as the electrical energy transporter, a photovoltaic power generation facility having capacity that can produce (generate) electricity of 1.6 KWH per hour is installed on the drone (in which, a 100 WH photovoltaic module that is produced and sold by Twinkle power Co., Ltd. in Korea is a flexible product, has a weight of 1.85 kg, dimensions of 3 mm thickness, about 1 m width, and about 0.5 m height, and produces electricity of 100 WH per hour using sunlight. 16 units of this photovoltaic module are installed on the electrical energy transporter in a structure that can receive sunlight well. In this case, the total of weight of the 16 photovoltaic modules is about 30 kg and the total of the electricity that the 16 photovoltaic modules produce (generate) is 1.6 KWH per hour).

Further, an electricity storage device that can store about 50 KWH (KVAH) is installed in the drone as the photovoltaic electricity storage device (for example, one industrial battery (electricity storage device) of 50 KWH (KVAH) that is produced and sold by Twinkle power Co., Ltd. in Korea can be installed and the weight of the industrial battery is 67 kg).

An electrical circuit is configured such that the electricity produced (generated) by the photovoltaic power generation facility installed on the one drone can be accumulated (stored) in the electricity storage device.

When the drone is flown to the sky, the drone can produce and store photovoltaic electricity of 1.6 KWH per hour, and when the drone stays for about 31 hours in the sky, the drone can store (accumulate) electricity of total 50 KWH (KVAH) (by continuously following the sun and moving to receive the direct sunlight to be irradiated well by sunlight for 24 hours a day), and can return to a designated electrical energy distribution place.

Further, in this case, assuming that the weight of the drone and the other facilities is about 50 kg, the total weight of the one drone is about 150 kg.

Accordingly, it is assumed that one drone of 150 kg is flown to the sky only by buoyancy in the air without separate energy consumption and helium gas is selected as a buoyant substance, which generates buoyancy in the air, from substances that are smaller in density than the air, and is applied to achieve the objective of this embodiment.

In order to fly (lift or hold) the one drone of this example in the sky using only buoyancy, when a coated chamber is formed in the one drone (assuming that the leakage rate of the helium gas is zero by the coating) such that the chamber is positioned at the center of the center of gravity of the drone and has a volume of 120 m³ or more in the chamber and the volume of the entire one drone is at most 120 m³ or more, and then the chamber is filled up with the helium gas (on the basis of the atmospheric pressure), the drone of this example is gradually moved up to the air (atmosphere) only by the force of nature (air buoyancy). Accordingly, it is possible to achieve the objective of manufacturing one drone of which the total weight is 150 kg, and flying the drone to the sky using only the buoyancy in the air without separate energy consumption.

Further, when simultaneously flying and staying 19,000 drones in the sky for 31 hours and then returning them to a designated electrical energy distribution place in Seoul of Korea in the way described above, it is possible to obtain a total of 950,000 KWH electrical energy. 950,000 KWH electrical energy is the same as the amount of the electricity that is produced for 1 hour by one nuclear reactor of a nuclear power plant in Korea (the capacity of one nuclear reactor of Hanul Nuclear Power Plant is 950,000 KWH).

Further, when this method is repeated, that is, when 589,000 drones are divided into 31 groups and 19,000 of each group are flown to the sky every 1 hour, after 1 hour passes from the first start point in time,

each of 19,000 drones produces and stores 50 KWH (KVAH) and returns to the ground every 1 hour, whereby it is possible to obtain electricity of 950,000 KWH for free per hour.

By repeating this method, it is possible to obtain electricity of 950,000 KWH per hour for 24 hours a day throughout the year, further, almost permanently (eternally) without the limitation of energy exhaustion.

As a result, a result like generating electricity by operating (driving) one 950,000 KWH nuclear reactor permanently without a rest is obtained.

Further, by expanding the method, that is, when operating millions of drones, hundreds of millions of drones, or countless drones in the method, humans can continuously obtain (can be continuously supplied with) an almost infinite amount of safe and clean electrical energy (photovoltaic electricity) almost permanently (eternally) without the limitation of energy exhaustion in the future.

As described above, by using the present disclosure, humans can continuously obtain an almost infinite amount of electrical energy (photovoltaic electricity) almost permanently (eternally) without the limitation of energy exhaustion in a clear and safe method in the future.

Further, the drone is increased in size such that a photovoltaic power generation facility being able to produce more electricity and an electricity storage device being able to store more electricity can be mounted (the capacities of a photovoltaic power generation facility and an electricity storage device are increased by increasing the magnitude of the buoyancy of the electrical energy transporter), or the drone is improved in performance to be able to easily carry larger weight by increasing the time for which it stays in the sky or space, and time for the drone stays in the sky or space is increased.

When countless units of such drones are manufactured over hundreds of thousands or hundreds of millions and produce, store, and bring electricity to a great number of designated electrical energy distribution places of <Embodiment 1> installed on the ground and sea, or in the air (such as Seoul charging station) while continuously reciprocating between the sky and the designated electrical energy distribution places in the method described above, humans can produce (generate) and obtain an almost infinite amount of energy in an almost permanent (eternal), most safe, and clean method in the future by the technology of the present disclosure. Further, assuming that the energy (electricity) is future energy,

it will be possible to completely replace fossil energy with the future energy that is taken from the sky or space, it will possible to reduce or completely shut down nuclear power plants, and it will also possible to completely solve the environment problem of the earth and the energy exhaust problem.

Consequently, the above description is rearranged.

A method of enabling humans to almost infinitely and almost permanently produce (generate) electricity (energy) that is clean energy obtained by photovoltaics as substitute energy for fossil fuels using the atmospheric power generation system of the present disclosure in the future is described.

The electrical energy transporter in the step (c) of <Embodiment 1> is an aircraft that at least includes:

the photovoltaic power generator that is a photovoltaic power generation facility producing (generating) electrical energy using the light energy from the sun in the sky or in space in the step (a) of <Embodiment 1>,

the electricity storage device 20 including the function of storing (accumulating) the electricity produced (generated) by the photovoltaic power generator 10 in the sky or in space and transmitting the stored (accumulated) electricity to designated electrical energy distribution places in the step (b) in <Embodiment 1>;

a configuration connecting electrical circuits to each other so that the electricity produced (generated) by the photovoltaic power generator is stored (accumulate) in the electricity storage device while staying in the sky or in space (outer space); and

a configuration returning to the designated electrical energy distribution places and transmitting the electrical energy brought from the sky or space, and

continuously repeats the electricity producing/transporting cycle one time or two or more times between the designated electrical energy distribution places and the sky or space,

thereby storing (accumulating) the photovoltaic electricity produced (generated) by the photovoltaic power generator in the sky or in space to the electricity storage device and then brings the electricity to the designated electrical energy distribution places.

A plurality of units of such aircrafts over one or two units or countless units of such aircrafts are manufactured and a plurality of units of such designated electrical energy distribution places over one or two units or countless units of such designated electrical energy distribution places are also constructed.

The plurality of units of aircrafts over one or two units or countless units of aircrafts are launched to the sky or space (outer space).

The aircrafts produce (generate) photovoltaic electricity through the photovoltaic power generators mounted on the main bodies and accumulate (store) the electricity in the electricity storage devices mounted on the main bodies while staying in the sky or space (outer space), and then return and transmit the electricity to the designated electrical energy distribution places.

Further, the aircrafts are launched again to the sky or space (outer space), produce (generate) and accumulate (store) photovoltaic electricity again while staying in the sky or space (outer space), and then return again to the designated electrical energy distribution places and transmit the brought electricity. The aircrafts continuously repeat this process several times over one or two times, or countless times, and the photovoltaic electricity brought in this way is transmitted to the designated electrical energy distribution places. The electricity transmitted to the designated electrical energy distribution places is transmitted, delivered, or sent to customers requiring energy (electricity) on the ground, whereby the electricity is supplied to humans.

Further, a method of making the electrical energy transporter be more effective

is to manufacture a drone as the aircraft and use the drone as the electrical energy transporter.

Further, there is a method of enabling the drone to produce (generate) more electrical energy in the sky or space and more effectively bring the electrical energy to humans.

This method is to increase the size of the drone to be able to mount a photovoltaic power generator that can generate more electricity and an electricity storage device that can store more electricity (or to increase the magnitude of the buoyancy of the electrical energy transporter), thereby increasing the capacities of the photovoltaic power generator and the electricity storage device to be flown. For example, one electrical energy transporter is manufactured to have a length of 1 km or more, a width of 1 km or more, and a height of 100 m or more and large buoyancy is generated using the various methods described above so that the huge electrical energy transporter can be flown to the sky or space by only the buoyancy. In this case, a photovoltaic power generator having a huge capacity and an electricity storage device having a huge capacity can be mounted on the huge electrical energy transporter. Accordingly, when the huge electrical energy transporter goes up to the sky or space and produces (generates) and brings photovoltaic electricity, the electrical energy transporter may produce (generate) more electrical energy and more effectively bring the electrical energy to humans in one operation. Alternately, other than this method, it may be possible to manufacture a drone that can stay for longer time in the sky or space.

Further, an electronic storage device that is mounted on the main body of the drone is formed in any one or more of a fixed type and a detachable type.

Such a detachable-type electricity storage device,

which is a standardized electricity storage device, is manufactured in a structure that can be separated and can be replaced with another electricity storage device when finishing storing (accumulating) electricity. Thereafter, the detachable-type electricity storage device is mounted on the drone, goes up to the sky or space, stores (accumulates) electricity produced (generated) by the photovoltaic power generator, returns to a designated electrical energy distribution place, and is then unloaded at the designated electrical energy distribution place. Further, another detachable-type electricity storage device to be charged is mounted on the drone and flown to the sky to accumulate electricity, and is then returned and unloaded. This process is repeated.

The fixed-type electricity storage device,

which is a standardized electricity storage device, is manufactured in a structure that transmits (discharges) stored (accumulated) electricity to a corresponding large-capacity electricity storage device. Thereafter, the fixed-type electricity storage device is mounted on the drone, goes up to the sky or space, stores (accumulates) electricity produced (generated) by the photovoltaic power generator, returns to a designated electrical energy distribution place, and then transmits (discharges) the electricity to a large-capacity secondary electricity storage device installed at a designated electrical energy distribution place. Thereafter, the fixed-type electricity storage device mounted on the drone is flown again to the sky, accumulates electricity, and then returns and transmits (discharges) the electricity to the large-capacity secondary fixed type electricity storage device. The fixed-type electricity storage device repeats this process.

Further, it is effective that

the designated electrical energy distribution place is installed at any one or more positions of on the ground, on the water, on the sea, and in the air.

The function of the designated electrical energy distribution place is any one or more of:

a first function in which a drone equipped with the fixed-type electricity storage device goes up to the sky or space, stores (accumulates) electricity produced (generated) by the photovoltaic power generator in the fixed-type electricity storage device, and then returns to the designated electrical energy distribution place, the electricity is transmitted to a large-capacity secondary electricity storage device installed at the designated electrical energy distribution place (is accumulated in the secondary electricity storage device), and then the transmitted electricity is transmitted again to an electricity consumer (electricity customer);

a second function in which a drone equipped with the detachable-type electricity storage device goes up to the sky or space, stores (accumulates) electricity produced (generated) by the photovoltaic power generator in the detachable-type electricity storage device, returns to the designated electrical energy distribution place, and then unloads the charged electricity storage device, another electricity storage device to be charged is loaded on the drone, and the charged detachable-type electricity storage device brought from the sky or space is sent to an electricity consumer (electricity customer);

a third function in which the designated electrical energy distribution place is the electricity consumer (electricity customer), a drone equipped with the fixed-type electricity storage device goes up to the sky or space, stores (accumulates) electricity produced (generated) by the photovoltaic power generator in the fixed-type electricity storage device, and then returns to the electricity consumer (electricity customer), which is the designated electrical energy distribution place, and the electricity is transmitted to a secondary electricity storage device installed at the electricity consumer (electricity customer) (is accumulated in the secondary electricity storage device) to be used at the electricity consumer (electricity customer) that is the designated electrical energy distribution place;

a fourth function in which the designated electrical energy distribution place is the electricity consumer (electricity customer), a drone equipped with the detachable-type electricity storage device goes up to the sky or space, stores (accumulates) electricity produced (generated) by the photovoltaic power generator in the detachable-type electricity storage device, returns to the electricity consumer (electricity customer) that is the designated electrical energy distribution place, and then unloads the charged electricity storage device at the electricity consumer (electricity customer), another electricity storage device to be charged is loaded on the drone at the electricity consumer (electricity customer), and the electricity stored in the charged and unloaded detachable-type electricity storage device is used at the electricity consumer (electricity customer); and

a fifth function that uses a combination of the first function to the fourth function.

Further, in the first function,

the method of transmitting (accumulating) electricity to (in) a large-capacity secondary electricity storage device installed at the designated electrical energy distribution place, and then transmitting the received electricity to an electricity consumer (electricity customer) is any one or more of:

a first method that transmits (accumulates) electricity from the secondary electricity storage device to (in) a third electricity storage device manufactured to be loaded and delivered (transported) on transportation and then loads and delivers (transports) the charged third electricity storage device on transportation to an electricity consumer (electricity customer);

a second method that transmits (sends) the electricity of the secondary electricity storage device to a power system network of the country (or an electric power company) by connecting the secondary electricity storage device to the power system network;

a third method that constructs a power line between the secondary electricity storage device and the electricity consumer (electricity customer) and transmits (sends) the electricity of the secondary electricity storage device to the electricity consumer (electricity customer) through the constructed power line; and

a fourth method that uses a combination of the first method to the third method.

Further, in the second function,

the method of transmitting the electricity stored (accumulated) in the detachable-type electricity storage device and brought from the sky or space to an electricity consumer (electricity customer) is any one or more of:

a first method that loads the charged detachable-type electricity storage device on transportation and delivers (transports) the detachable-type electricity storage device on the transportation to the electricity consumer (electricity customer);

a second method that transmits (sends) the electricity stored in the detachable-type electricity storage device to the power system network of the country (or an electric power company);

a third method that constructs a power line between the charged detachable-type electricity storage device and the electricity consumer (electricity customer) and transmits (sends) the electricity of the detachable-type electricity storage device to the electricity consumer (electricity customer) through the constructed power line; and

a fourth method that uses a combination of the first method to the third method.

Further, the electricity consumer (electricity customer) receives and uses electricity brought from the sky or space is any one or more of:

a first method that receives (is provided with) any one or more of the charged detachable-type electricity storage device and the charged third electricity storage device and directly uses DC electricity supplied (discharged) therefrom;

a second method that receives (is provided with) any one or more of the charged detachable-type electricity storage device and the charged third electricity storage device and converts and uses DC electricity supplied (discharged) therefrom into AC electricity;

a third method in which electricity brought from the sky or space is transmitted (sent) to the power system network of the country (or an electric power company) and the electricity consumer (electricity customer) receives and uses composite electricity of the electricity transmitted to the power system network and the electricity existing in the power system network;

a fourth method that constructs a power line for directly sending electricity brought from the sky or space to the electricity consumer (electricity customer) so that the electricity consumer (electricity customer) directly receives and uses the electricity brought from the sky or space through the power line; and

a fifth method that uses a combination of the first method to the fourth method.

Further, in the first method,

in order for the electricity consumer (electricity customer) to receive (be provided with) any one or more of the charged detachable-type electricity storage device and the charged third electricity storage device and directly use DC electricity supplied (discharged) therefrom,

an electric load of the electricity consumer (electricity customer) is an electric heating load that generates heat using electricity and uses a portion or the entirety of an assembly-type heating wire that is operated by the electricity of a battery.

### Embodiment 10

The assembly-type heating wire that is operated by the electricity of a battery described in <Embodiment 8> and <Embodiment 9> is described in more detail.

The assembly-type heating wire is

formed by selecting two or more extra fine wires made of single metal or a metal alloy having different number of threads, different thicknesses, different materials, and different functions, and by assembling and bundling the extra fine wires into one bundle to have a low resistance value required to obtain desired heat using battery electricity coming out of the electricity storage device or safe low-voltage DC electricity of 24V or less, in which such one bundle is one heating wire.

Further, the desired heat is

the desired heat is

heat that is generated when a power amount corresponding to a desired amount of heat is consumed by the assembly-type heating wire and heat generation, in which a current value (a current amount) calculated by dividing a corresponding power value (power amount) by a voltage to be used entirely flows into the assembly-type heating wire at a corresponding voltage within a corresponding time, occurs to obtain a desired amount of heat or temperature within a desired time from the assembly-type heating wire.

Further, it is more effective

to assemble the assembly-type heating wire, which is operated by the electricity of a battery, to have a low resistance value required to obtain the desired heat using battery electricity coming out of the electricity storage device or safe low-voltage DC electricity at 24V or less, in any one of:

a first method that forms a composite by selecting extra fine wires (or an extra fine wire group or a mixture of extra fine wires and an extra fine wire group) having a resistance value per unit length higher than a conductor, and by combining the extra fine wires to be longitudinally electrically in contact with each other to reduce the composite resistance value while increasing the number of threads (or the number of groups, or the number of units) of the extra fine wires (or an extra fine wire group or a mixture of extra fine wires and an extra fine wire group) having a resistance value higher than a conductor, and then makes the composite in one bundle such that the bundle becomes a thread of heating wire;

a second method that makes two or more groups for selection, selects extra fine wires (or an extra fine wire group or a mixture of extra fine wires and an extra fine wire group) having a resistance value per unit length the same as or close to that of a conductor as a first group,

selects extra fine wires (or an extra fine wire group or a mixture of extra fine wires and an extra fine wire group) having a resistance value per unit length higher than that of a conductor as second and higher groups, and then

makes one bundle by combining the extra fine wires (or an extra fine wire group or a mixture of extra fine wires and an extra fine wire group) of the first group and the second and higher groups to be longitudinally electrically in contact with each other such that the bundle becomes a thread of heating wire;

a third method that makes two or more groups for selection, selects extra fine wires (or an extra fine wire group or a mixture of extra fine wires and an extra fine wire group) generating more heat and becoming a conductor to pass more current like a conductor without generating heat after reaching a predetermined temperature as a first group,

selects extra fine wires (or an extra fine wire group or a mixture of extra fine wires and an extra fine wire group) having a resistance value per unit length higher than that of a conductor as second and higher groups, and then

makes one bundle by combining the extra fine wires (or an extra fine wire group or a mixture of extra fine wires and an extra fine wire group) of the first group and the second and higher groups to be longitudinally electrically in contact with each other such that the bundle becomes a thread of heating wire;

a fourth method that makes three or more groups for selection, selects extra fine wires (or an extra fine wire group or a mixture of extra fine wires and an extra fine wire group) generating less heat and becoming a conductor to pass more current like a conductor without generating heat after reaching a predetermined temperature as a first group,

selects extra fine wires (or an extra fine wire group or a mixture of extra fine wires and an extra fine wire group) having a resistance value per unit length the same as or close to that of a conductor as a second group,

selects extra fine wires (or an extra fine wire group or a mixture of extra fine wires and an extra fine wire group) having a resistance value pet unit length higher than that of a conductor as third and higher groups, and then

makes one bundle by combining the extra fine wires (or an extra fine wire group or a mixture of extra fine wires and an extra fine wire group) of the first group, the second group, and the third and higher groups to be longitudinally electrically in contact with each other such that the bundle becomes a thread of heating wire; and

a fifth method that uses a combination of the first method to the fourth method.

Further, the material (substance) of the extra fine wires (or an extra fine wire group or a mixture of extra fine wires and an extra fine wire group) having a resistance value pet unit length that is the same or close to, or higher than that of a conductor in the first method to the fifth method is metal, and

any one or more of gold, white gold, silver, copper, aluminum, pure steel, tungsten, and nickel are used as the material.

Further, the material (substance) of the extra fine wires (or an extra fine wire group or a mixture of extra fine wires and an extra fine wire group) having a resistance value pet unit length that is the same or close to, or higher than that of a conductor in the first method to the fifth method is a metal alloy, and

any one of: a nickel-copper alloy-based metal alloy, a nickel-chrome alloy-based metal alloy, a steel-chrome alloy-based metal alloy, a steel-carbon alloy-based metal alloy, hard-drawn copper or hard-drawn copper alloy-based metal alloy, steel fiber (metal fiber) (NASLON), graphene or graphene mixture-based metal alloy, stainless-based (SUS 316 and SUS 314) metal alloy, pure steel or pure steel-contained metal alloy, a carbon-contained metal alloy;

a nickel-copper metal alloy composed of nickel of 20˜25 wt % and copper of 75˜80 wt %; and

a metal alloy produced composed of steel of 68˜73 wt %, chrome of 18˜22 wt %, alumina of 5˜6 wt %, and molybdenum of 3˜4 wt %.

Further, the material (substance) of the extra fine wires (or an extra fine wire group or a mixture of extra fine wires and an extra fine wire group) generating less heat and becoming a conductor to pass more current like a conductor without generating heat after reaching a predetermined temperature in the third method˜fifth method is a metal alloy, and

any one of more of a silicon-copper alloy-based metal alloy, a silicon-brass alloy-based metal alloy, and a silicon-steel alloy-based metal alloy.

Further, as the material of the extra fine wire groups in the first method˜fifth method,

any one or more of SUS 316- and SUS 304-based metal alloys, and

steel fiber (metal fiber) (NASLON).

Further, in the method of making the assembly-type heating wire that is operated by the electricity of a battery, the extra fine wires is bundled using any one of:

a first method that makes a composite of extra fine wires by bringing all extra fine wires in a bundle to be longitudinally in contact with each other from the start to the end such that the entire surfaces of the extra fine wires are longitudinally in contact with each other and a current can flow to all of the extra fine wires through the entire contact surfaces, coats several extra fine wires with a high-temperature fiber

by longitudinally wrapping the composite with the high-temperature fiber;

a second method that performs bundling by twisting the extra fine wires using a thread twister;

a third method that performs bundling by coating and pulling the extra fine wires using a coater;

a fourth method that performs bundling by performing the third method two or more times;

a fifth method that uses different coating materials for each number of times while performing the fourth method;

a sixth method that performs bundling by putting the bundle obtained through the first method or the second method into a coater and then coating and pulling them one time or two or more times;

a seventh method that performs bundling by putting and coating the bundle obtained through the first method or the second method in a coater one time or two or more times, and pulling them while using the same coating material for each number of times, using different materials for some numbers of times, or using different material for all numbers of times;

an eighth method that performs bundling by putting the extra fine wires between the top and the bottom of a plate-shaped material, injecting an adhesive, and then melting the adhesive; and

a ninth method that performs bundling by putting any one of the bundles made by the first method to the eighth method between the top and the bottom of a plate-shaped material, injecting an adhesive, and then melting the adhesive.

Further, as the high-temperature fiber coating in the first, sixth, and seventh to methods,

any one or more of fibers (carbon fibers) made of aramid, polyarylate, xyron, and grapheme are used.

Further, as the coating in the third, fourth, fifth, sixth, seventh, and ninth methods,

any one or more of Teflon, PVC, silicon, grapheme, ceramic, ceramics, carbon black, refractocoat that is a ceramic coating, tetraethyl ortho[silicate (TEOS)+putty in which siliceous zircon powder is distributed in a liquid-state binder reacting with silica sol], cerakwool, and aerogel.

1. A method for implementing an atmospheric power generation system, the method comprising:
(a) configuring a photovoltaic power generator that is a photovoltaic power generation facility producing (generating) electricity using light energy of the sun in the sky;
(b) configuring an electricity storage device storing (accumulating) electricity produced (generated) by the photovoltaic power generator in the sky such that the stored (accumulated) electricity can be transmitted to a designated electrical energy distribution place;
(c) configuring an electrical energy transporter including the photovoltaic power generator and the electricity storage device and performing an electricity producing/transporting cycle one time or continuously two or more times between the sky and the designated electrical energy distribution place;
(d) configuring a designated electrical energy distribution place receiving electrical energy brought by the electrical energy transporter from the sky by producing (generating) and storing photovoltaic electricity, or transmitting the received electrical energy to an electricity consumer;
(e) connecting electrical circuits such that electricity produced (generated) by the photovoltaic power generator is stored (accumulated) in the electricity storage device while the electrical energy transporter stays in the sky; and
(f) bringing electrical energy produced (generated) in the sky to the designated electrical energy distribution place by performing the electricity producing/transporting cycle between the sky and the designated electrical energy distribution place by means of the electrical energy transporter.

2. The method of claim 1, wherein the electrical energy transporter is manufactured such that a total amount of electrical energy produced (generated) and brought (transported) to the designated electrical energy distribution place from the sky through one time of the electricity producing/transporting cycle is larger than a total amount of energy that is used (consumed) through one time of the electricity producing/transporting cycle.

3. The method of claim 2, the total amount of electrical energy produced (generated) and brought (transported) to the designated electrical energy distribution place from the sky through one time of the electricity producing/transporting cycle is made larger than the total amount of energy that is used (consumed) through one time of the electricity producing/transporting cycle,
by using force (energy) of nature as a portion of energy required to operate (driving) the electrical energy transporter.

4-5. (canceled)

6. The method of claim 3, wherein the force (energy) naturally obtained using the principle of nature is buoyancy that pushes up an object in the air opposite the gravity of the earth.

7. (canceled)

8. The method of claim 1, wherein in order to manufacture the electrical energy transporter to generate buoyancy, weight (mass) corresponding to a volume of the electrical energy transporter is made smaller than weight (mass) to the same volume of surrounding air.

9. The method of claim 8, wherein the weight (mass) corresponding to the volume of the electrical energy transporter is made smaller than the weight (mass) to the same volume of the surrounding air by any one or more of:
a first method including any one or more of a way that generates natural buoyancy by forming a chamber having a predetermined volume in the electrical energy transporter and filling the chamber with the buoyant substance, a way that generates artificial buoyancy by applying negative pressure (minus pressure) or vacuum to the chamber, and a way that configures a buoyant device having any one of the natural buoyancy and artificial buoyancy for the electrical energy transporter;
a second method of separately additionally configuring a buoyant device having any one or more of the natural buoyancy and artificial buoyancy for the electrical energy transporter; and
a third method being able to adjust the magnitude of buoyancy of any one or more of the chamber having a predetermined volume in the electrical energy transporter, the buoyant device disposed in the electrical energy transporter, and the buoyant device separately additionally provided the electrical energy transporter in the first method and the second method.

10-17. (canceled)

18. The method of claim 1, wherein the electricity producing/transporting cycle is a sequential process in which the electrical energy transporter flies up to the sky, produces (generates) and accumulates (stores) photovoltaic electricity while staying in the sky, and then returns to the designated electrical energy distribution place and transmits brought electrical energy.

19-28. (canceled)

29. The method of claim 1, wherein, in the step (f),
one, or two or more several units of the electrical energy transporter are manufactured and one, or two or more several units of the designated electrical energy distribution place are formed,
the electrical energy transporters fly up to the sky,
the electrical energy transporters produce (generate) photovoltaic electrical energy through photovoltaic power generators mounted on main bodies and accumulate (store) the photovoltaic electrical energy in electricity storage devices mounted on the main bodies while staying in the sky, and then return and transmit the brought photovoltaic electrical energy to the designated electrical energy distribution places,
the electrical energy transporters fly up again to the sky, produce (generate) and accumulate (store) photovoltaic electrical energy again while staying in the sky, and then return again to the designated electrical energy distribution places and transmit the brought electrical energy, and continuously repeat this process one time or two or more times,
whereby the photovoltaic electrical energy brought in this way is transmitted to the designated electrical energy distribution places, and then transmitted to the designated electrical energy distribution places, delivered, or sent to each electricity consumer (electricity customer) on the ground.

30. The method of claim 1, wherein the electrical energy transporter is an aircraft.

31. The method of claim 30, wherein the aircraft is a drone.

32-44. (canceled)

45. An atmospheric power generation system comprising:
a photovoltaic power generator that is a photovoltaic power generation facility producing (generating) electricity using light energy of the sun in the sky;
an electricity storage device connected to photovoltaic power generator through electrical circuits, storing (accumulating) electricity produced (generated) by the photovoltaic power generator in the sky such that the stored (accumulated) electricity can be transmitted to a designated electrical energy distribution place;
an electrical energy transporter including the photovoltaic power generator and the electricity storage device and performing an electricity producing/transporting cycle one time or continuously two or more times between the sky and the designated electrical energy distribution place; and
a designated electrical energy distribution place receiving electrical energy brought by the electrical energy transporter from the sky by producing (generating) and storing photovoltaic electricity, or transmitting the received electrical energy to an electricity consumer,
wherein the electrical energy transporter brings electrical energy produced (generated) in the sky to the designated electrical energy distribution place by performing the electricity producing/transporting cycle between the sky and the designated electrical energy distribution place.

46. The atmospheric power generation system of claim 45, wherein the electrical energy transporter is manufactured such that a total amount of electrical energy produced (generated) and brought (transported) to the designated electrical energy distribution place from the sky through one time of the electricity producing/transporting cycle is larger than a total amount of energy that is used (consumed) through one time of the electricity producing/transporting cycle.

47. The atmospheric power generation system of claim 46, wherein force (energy) of nature is used as a portion of energy required to operate (drive) the electrical energy transporter.

48-49. (canceled)

50. The atmospheric power generation system of claim 47, wherein the force (energy) naturally obtained using the principle of nature is buoyancy that pushes up an object in the air opposite the gravity of the earth.

51. (canceled)

52. The atmospheric power generation system of claim 47, wherein the buoyancy is generated by making weight (mass) corresponding to a volume of the electrical energy transporter smaller than weight (mass) to the same volume of surrounding air.

53-61. (canceled)

62. The atmospheric power generation system of claim 45, wherein the electricity producing/transporting cycle is a sequential process in which the electrical energy transporter flies up to the sky, produces (generates) and accumulates (stores) photovoltaic electricity while staying in the sky, and then returns to the designated electrical energy distribution place and transmits brought electrical energy.

63-77. (canceled)

78. The atmospheric power generation system of claim 45, wherein the electrical energy transporter is an aircraft.

79. The atmospheric power generation system of claim 78, wherein the aircraft is a drone.

80. The atmospheric power generation system of claim 45, wherein the electricity storage device is mounted on the electrical energy transporter in any one or more of a fixed type and a detachable type.

81-92. (canceled)
